(19) United States
(12) Patent Application Publication
(10) Pub. No.: US 2021/0391963 A1
(43) Pub. Date: Dec. 16, 2021

(54) SOUNDING REFERENCE SIGNAL (SRS) RESOURCE CONFIGURATION TECHNIQUES

(71) Applicant: QUALCOMM Incorporated, San Diego, CA (US)

(72) Inventors: Muhammad Sayed Khairy Abdelghaffar, San Jose, CA (US); Alexandros Manolakos, Escondido, CA (US); Ahmed Attia Abotabl, San Diego, CA (US)

(21) Appl. No.: 17/022,585

(22) Filed: Sep. 16, 2020

(30) Foreign Application Priority Data
Jun. 12, 2020 (GR) 20200100339

(51) Int. Cl. H04L 5/00; H04W 72/04; H04L 12/24

(52) U.S. Cl. CPC H04L 5/0048; H04W 72/0453; H04L 41/0896; H04W 72/0406

(57) ABSTRACT

Techniques related to reference signals and reference signal allocations are provided. In some implementations, a method of wireless communication includes receiving, at a user equipment (UE) from an electronic device, an indicator that indicates an allocation of a sounding reference signal (SRS) to multiple disjoint frequency resources of one or more resource bandwidths (BWs). The method further includes transmitting, to the electronic device, the SRS via the multiple disjoint frequency resources in accordance with the allocation of the SRS. Other aspects and features are also claimed and described.

### CROSS-REFERENCE TO RELATED APPLICATIONS

This application claims the benefit of Greek Patent Application No. 20200100339, entitled, “SOUNDING REFERENCE SIGNAL (SRS) RESOURCE CONFIGURATIONS FOR SUB-BAND FULL DUPLEX OPERATION,” filed on Jun. 12, 2020, which is expressly incorporated by reference herein in its entirety.

### TECHNICAL FIELD

Aspects of the present disclosure relate generally to wireless communication systems, and more particularly, to reference signaling and associated resource configurations (e.g., sounding reference signal (SRS) and associated resource configurations). Some features can enable and provide improved communications, including full duplex communications (e.g., sub-band full duplex or SBFD).

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing available network resources.

A wireless communication network may include several components. These components can include wireless communication devices, such as base stations (or node Bs) that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE and/or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes receiving, at a user equipment (UE) from an electronic device (e.g., a network entity), an indicator that indicates an allocation of a sounding reference signal (SRS) to multiple disjoint frequency resources of one or more resource bandwidths (BWs) (e.g., of a bandwidth part (BWP)). The method further includes transmitting, to the electronic device, the SRS via the multiple disjoint frequency resources in accordance with the allocation of the SRS.

In an additional aspect of the disclosure, an apparatus configured for wireless communication is disclosed. The apparatus includes at least one processor, and a memory coupled to the at least one processor. The at least one processor is configured to receive, at a user equipment (UE) from an electronic device, an indicator that indicates an allocation of a sounding reference signal (SRS) to multiple disjoint frequency resources of one or more resource bandwidths (BWs). The at least one processor is further configured to initiate transmission, to the electronic device, of the SRS via the multiple disjoint frequency resources in accordance with the allocation of the SRS.

In an additional aspect of the disclosure, an apparatus configured for wireless communication is disclosed. The apparatus includes means for receiving, at a user equipment (UE) from an electronic device, an indicator that indicates an allocation of a sounding reference signal (SRS) to multiple disjoint frequency resources of one or more resource bandwidths (BWs). The apparatus further includes means for transmitting, to the electronic device, the SRS via the multiple disjoint frequency resources in accordance with the allocation of the SRS.

In an additional aspect of the disclosure, a non-transitory computer-readable medium stores instructions that, when executed by a processor, cause the processor to perform operations including receiving, at a user equipment (UE) from an electronic device, an indicator that indicates an allocation of a sounding reference signal (SRS) to multiple disjoint frequency resources of one or more resource bandwidths (BWs). The operations further include initiating transmission, to the electronic device, of the SRS via the multiple disjoint frequency resources in accordance with the allocation of the SRS.

In an additional aspect of the disclosure, a method of wireless communication includes transmitting, from an electronic device (e.g., a network entity) to a user equipment (UE), an indicator that indicates an allocation of a sounding reference signal (SRS) to multiple disjoint frequency resources of one or more resource bandwidths (BWs) (e.g., of a bandwidth part (BWP)). The method further includes receiving, from the UE, the SRS via the multiple disjoint frequency resources in accordance with the allocation of the SRS.

In an additional aspect of the disclosure, an apparatus configured for wireless communication is disclosed. The apparatus includes at least one processor, and a memory coupled to the at least one processor. The at least one processor is configured to initiate transmission, from an electronic device to a user equipment (UE), of an indicator that indicates an allocation of a sounding reference signal (SRS) to multiple disjoint frequency resources of one or more resource bandwidths (BWs). The at least one processor is further configured to receive, from the UE, the SRS via the multiple disjoint frequency resources in accordance with the allocation of the SRS.

In an additional aspect of the disclosure, an apparatus configured for wireless communication is disclosed. The apparatus includes means for transmitting, from an electronic device to a user equipment (UE), an indicator that indicates an allocation of a sounding reference signal (SRS) to multiple disjoint frequency resources of one or more resource bandwidths (BWs). The apparatus further includes means for receiving, from the UE, the SRS via the multiple disjoint frequency resources in accordance with the allocation of the SRS.

In an additional aspect of the disclosure, a non-transitory computer-readable medium stores instructions that, when executed by a processor, cause the processor to perform operations including initiating transmission, from an electronic device to a user equipment (UE), of an indicator that indicates an allocation of a sounding reference signal (SRS) to multiple disjoint frequency resources of one or more resource bandwidths (BWs). The operations further include receiving, from the UE, the SRS via the multiple disjoint frequency resources in accordance with the allocation of the SRS.

In an additional aspect of the disclosure, a method of wireless communication includes receiving, at a user equipment (UE) from an electronic device (e.g., a network node), a configuration message indicating division of a bandwidth part (BWP) into multiple resource bandwidths (BWs). The method includes receiving, from the electronic device, an indication of an allocation of a sounding reference signal (SRS) to the BWP. The method also includes receiving, from the electronic device, an indication of an active resource BW of the multiple resource BWs. The method further includes transmitting, to the electronic device, the SRS via one or more frequency resources that overlap between the active resource BW and the allocation of the SRS.

In an additional aspect of the disclosure, an apparatus configured for wireless communication is disclosed. The apparatus includes at least one processor, and a memory coupled to the at least one processor. The at least one processor is configured to receive, at a user equipment (UE) from an electronic device, a configuration message indicating division of a bandwidth part (BWP) into multiple resource bandwidths (BWs). The at least one processor is configured to receive, from the electronic device, an indication of an allocation of a sounding reference signal (SRS) to the BWP. The at least one processor is also configured to receive, from the electronic device, an indication of an active resource BW of the multiple resource BWs. The at least one processor is further configured to initiate transmission, to the electronic device, of the SRS via one or more frequency resources that overlap between the active resource BW and the allocation of the SRS.

In an additional aspect of the disclosure, an apparatus configured for wireless communication is disclosed. The apparatus includes means for receiving, at a user equipment (UE) from an electronic device, a configuration message indicating division of a bandwidth part (BWP) into multiple resource bandwidths (BWs). The apparatus includes means for receiving, from the electronic device, an indication of an allocation of a sounding reference signal (SRS) to the BWP. The apparatus also includes means for receiving, from the electronic device, an indication of an active resource BW of the multiple resource BWs. The apparatus further includes means for transmitting, to the electronic device, the SRS via one or more frequency resources that overlap between the active resource BW and the allocation of the SRS.

In an additional aspect of the disclosure, a non-transitory computer-readable medium stores instructions that, when executed by a processor, cause the processor to perform operations including receiving, at a user equipment (UE) from an electronic device, a configuration message indicating division of a bandwidth part (BWP) into multiple resource bandwidths (BWs). The operations include receiving, from the electronic device, an indication of an allocation of a sounding reference signal (SRS) to the BWP. The operations also include receiving, from the electronic device, an indication of an active resource BW of the multiple resource BWs. The operations further include initiating transmission, to the electronic device, of the SRS via one or more frequency resources that overlap between the active resource BW and the allocation of the SRS.

In an additional aspect of the disclosure, a method of wireless communication includes transmitting, from an electronic device (e.g., a network node) to a user equipment (UE), a configuration message indicating division of a bandwidth part (BWP) into multiple resource bandwidths (BWs). The method includes transmitting, to the UE, an indication of an allocation of a sounding reference signal (SRS) to the BWP. The method also includes transmitting, to the UE, an indication of an active resource BW of the multiple resource BWs. The method further includes receiving, from the UE, the SRS via one or more frequency resources that overlap between the active resource BW and the allocation of the SRS.

In an additional aspect of the disclosure, an apparatus configured for wireless communication is disclosed. The apparatus includes at least one processor, and a memory coupled to the at least one processor. The at least one processor is configured to initiate transmission, from an electronic device to a user equipment (UE), of a configuration message indicating division of a bandwidth part (BWP) into multiple resource bandwidths (BWs). The at least one processor is configured to initiate transmission, to the UE, of an indication of an allocation of a sounding reference signal (SRS) to the BWP. The at least one processor is also configured to initiate transmission, to the UE, of an indication of an active resource BW of the multiple resource BWs. The at least one processor is further configured to receive, from the UE, the SRS via one or more frequency resources that overlap between the active resource BW and the allocation of the SRS.

In an additional aspect of the disclosure, an apparatus configured for wireless communication is disclosed. The apparatus includes means for transmitting, from an electronic device to a user equipment (UE), a configuration message indicating division of a bandwidth part (BWP) into multiple resource bandwidths (BWs). The apparatus includes means for transmitting, to the UE, an indication of an allocation of a sounding reference signal (SRS) to the BWP. The apparatus also includes means for transmitting, to the UE, an indication of an active resource BW of the multiple resource BWs. The apparatus further includes means for receiving, from the UE, the SRS via one or more frequency resources that overlap between the active resource BW and the allocation of the SRS.

In an additional aspect of the disclosure, a non-transitory computer-readable medium stores instructions that, when executed by a processor, cause the processor to perform operations including initiating transmission, from an electronic device to a user equipment (UE), of a configuration message indicating division of a bandwidth part (BWP) into multiple resource bandwidths (BWs). The operations include initiating transmission, to the UE, of an indication of an allocation of a sounding reference signal (SRS) to the BWP. The operations also include initiating transmission, to the UE, of an indication of an active resource BW of the multiple resource BWs. The operations further include receiving, from the UE, the SRS via one or more frequency resources that overlap between the active resource BW and the allocation of the SRS.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects the exemplary aspects can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system according to some aspects of the present disclosure.

FIG. 2 is a block diagram illustrating a design of a base station and a UE configured according to some aspects.

FIG. 3A is a diagram of a first example of full-duplex operations according to some aspects.

FIG. 3B is a diagram of a second example of full-duplex operations according to some aspects.

FIG. 4A is a diagram of a first example of allocating resources for full-duplex operations according to some aspects.

FIG. 4B is a diagram of a second example of allocating resources for full-duplex operations according to some aspects.

FIG. 4C is a diagram of a third example of allocating resources for full-duplex operations according to some aspects.

FIG. 5 is a diagram of a division of an active bandwidth part (BWP) into multiple resource bandwidths (BWs) according to some aspects.

FIG. 6 is a block diagram illustrating an example wireless communication system configured to allocate a sounding reference signal (SRS) resource to multiple disjoint frequency resources of one or more resource BWs according to some aspects.

FIGS. 7A-7C are diagrams of examples of allocation of uplink (UL), downlink (DL), and SRS resources to a sub-band full duplex (SBFD) configured UE or an in-band full duplex (IBFD) configured UE according to some aspects.

FIG. 8 is a block diagram illustrating an example wireless communication system configured to allocate SRS resources based on an active BWP according to some aspects.

FIG. 9 is a diagram of an example of allocation of SRS resources to a full duplex configured UE according to some aspects.

FIG. 10 illustrates an example of configuring SRS resources based on detected collisions according to some aspects.

FIG. 11 is a flow diagram illustrating an example process of UE operations for transmitting a SRS via an SRS resource allocated to multiple disjoint frequency resources of one or more resource BWs according to some aspects.

FIG. 12 is a flow diagram illustrating an example process of UE operations for transmitting a SRS via SRS resources allocated based on a resource BW of an active BWP according to some aspects.

FIG. 13 is a block diagram illustrating an example of a UE configured to transmit a SRS based on an SRS resource allocation according to some aspects.

FIG. 14 is a flow diagram illustrating an example process of network entity operations for indicating an allocation of an SRS resource to multiple disjoint frequency resources of one or more resource BWs according to some aspects.

FIG. 15 is a flow diagram illustrating an example process of network node operations for indicating an allocation of SRS resources based on a resource BW of an active BWP according to some aspects.

FIG. 16 is a block diagram illustrating an example of a network node configured to indicate one or more allocations of an SRS resource according to some aspects.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

According to some aspects, user equipments (UEs) and base stations may communicate reference signals to enable measurement of wireless channels between the UEs and base stations. One type of reference signal is a sounding reference signal (SRS). A UE typically transmits a SRS to a base station to enable the base station to measure channel quality of an uplink channel from the UE to the base station for each subsection of a frequency region. The base station typically allocates one or more SRS resources (e.g., one or more contiguous frequency sub-bands) for use by the UE in transmission of the SRS. Although this allocation of SRS resources is effective for UEs that are capable of communicating in one direction at a time, this allocation of SRS resources may be challenging for UEs that are configured for sub-band full duplex operations (e.g., UEs capable of concurrently transmitting on the uplink and receiving on the downlink) and that may be allocated disjoint frequency resources for communications on the uplink.

Aspects of the present disclosure provide systems, apparatus, methods, and computer-readable media for enabling allocation of and use of reference signals. For example, allocating and using a sounding reference signal (SRS). As a particular example, UEs may utilize SRSs for sub-band full duplex operation. A UE may be configured to perform concurrent downlink (DL) reception and uplink (UL) transmission (e.g., via different antenna panels or subsets of an antenna array). The sub-band full duplex operations may include in-band full duplex (IBFD) (e.g., operations in which the DL resources and the UL resources overlap in time and at least partially overlap in frequency) or sub-band frequency division duplex (FDD) (e.g., operations in which the DL resources and the UL resources overlap in time but not in frequency, also referred to herein as “flexible duplex”). The SRS may be allocated based on the allocation of frequency resources to the UL to support SRS transmission by a UE configured for sub-band full duplex operations.

In some implementations of discussed aspects (e.g., SBFD operations), a UE may be allocated multiple disjoint frequency resources (e.g., frequency sub-bands) for communications (e.g., uplink, downlink, sidelink, peer-to-peer (P2P), device-to-device (D2D), etc.). Disjoint frequency usage generally refers to using frequencies or frequency bands that do not overlap in the frequency domain (e.g., that do not include any resource blocks in common). In some UL communication scenarios, utilized disjoint frequencies may be separated in frequency by one or more frequency resources allocated for DL communication (e.g., to the UE or to another UE). For example, a component carrier (CC) BW in SBFD may be split in frequency between DL and UL, such that a UL band is allocated at both edges of the CC BW with the DL band in between.

Various techniques described herein enable allocation of an SRS to disjoint frequency resources of one or more resource bandwidths (BWs) to enable SRS transmission via a divided UL band. For example, a UE may receive, from a base station, an indicator that indicates an allocation of an SRS to multiple disjoint frequency resources (e.g., multiple disjoint sub-bands) of one or more resource BWs of a bandwidth part (BWP) (e.g., a subdivision of a carrier that has its own numerology and configuration). The UE may then transmit the SRS to the base station via the multiple disjoint frequency resources in accordance with the allocation of the SRS. For example, one or more SRS resources (e.g., a single SRS resource or a single SRS resource set) may be configured for each frequency resource of a resource BW of the BWP, with different frequency domain parameters for each frequency resource (e.g., sub-band).

In some implementations, one or more SRS resources may be allocated at the BWP level. For example, an active BWP may be divided into multiple resource BWs. This may include, for example, contiguous sub-bands or multiple disjoint sub-bands within the active BWP. The SRS may be allocated to overlap in frequency with a selected resource BW of the multiple resource BWs. For example, a UE may receive, from a network node, a configuration message indicating division of a BWP into multiple resource BWs. The UE may also receive, from the network node, an indication of an allocation of an SRS to the BWP and an indication of an active resource BW of the multiple resource BWs. The UE may transmit, to the network node, the SRS via one or more frequency resources that overlap between the active resource BW and the allocation of the SRS (e.g., via a portion of a single SRS resource or a single SRS resource set that overlaps with the active resource BW). Because the active resource BW may be a contiguous set of sub-bands or multiple disjoint sub-bands, the SRS may be allocated to a contiguous set of sub-bands or multiple disjoint sub-bands. Additionally or alternatively, if the network node is a base station, division of the active BWP into multiple resource BWs may include division into one or more DL resource BWs and one or more UL resource bandwidths. Alternatively, the network node may be a second UE, and the resource BWs may be allocated for a sidelink (SL) between the UE and the second UE.

Particular implementations of the subject matter described in this disclosure can be implemented to realize one or more of the following potential advantages and/or benefits. In some aspects, the present disclosure provides techniques for enabling allocation of an SRS to multiple disjoint sub-bands. The SRS may be allocated via radio resource control (RRC) configuration, which may require minimal modifications to legacy wireless communication systems. Alternatively, the SRS may be allocated based on selection of a BW within an active BWP (e.g., at the BWP level). This type of SRS allocation may have more flexibility for multiplexing and configuring communications by multiple UEs, as well as enabling communications with different parameters. The above-described SRS allocation techniques may be used to perform SRS transmissions by UEs configured to perform full duplex operations (e.g., IBFD or SBFD operations) or half duplex operations.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The Third Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. Additionally, an operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects descried with reference to one technology may be understood to be applicable to another technology. Indeed, one or more aspects of the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. In some practical settings, devices incorporating described aspects and features may also necessarily include additional components and features for implementation and practice of claimed and described embodiments. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

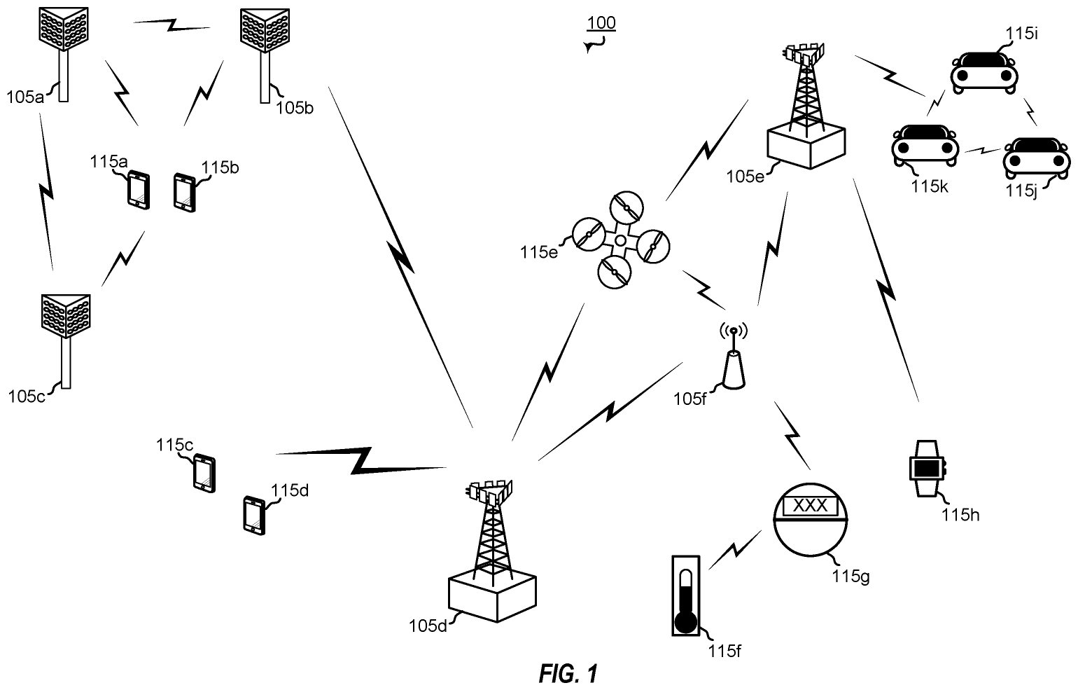

FIG. 1 is a block diagram illustrating details of an example wireless communication system. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component device/module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink and/or uplink, or desired transmission between base stations, and backhaul transmissions between base stations. UEs may operate as base stations or other network nodes in some scenarios. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

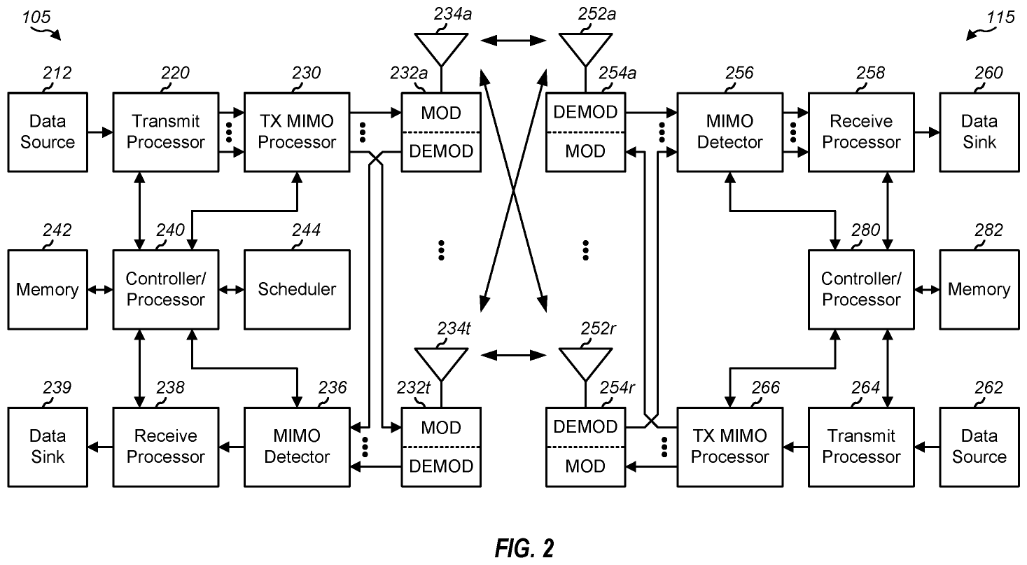

FIG. 2 shows a block diagram conceptually illustrating an example design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, the antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller/processor 280.

On the uplink, at UE 115, transmit processor 264 may receive and process data (e.g., for the physical uplink shared channel (PUSCH)) from data source 262 and control information (e.g., for the physical uplink control channel (PUCCH)) from controller/processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller/processor 240.

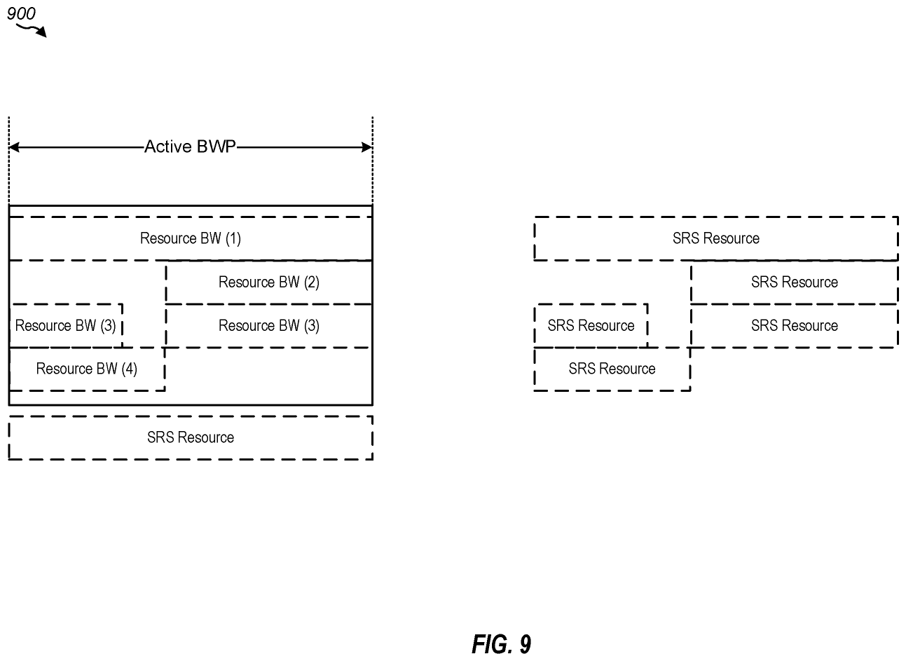

Controllers/processors 240 and 280 may direct the operation at base station 105 and UE 115, respectively. Controller/processor 240 and/or other processors and modules at base station 105 and/or controller/processor 280 and/or other processors and modules at UE 115 may perform or direct the execution of various processes for the techniques described herein, such as to perform or direct the execution illustrated in FIGS. 11, 12, 14, and 15, and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

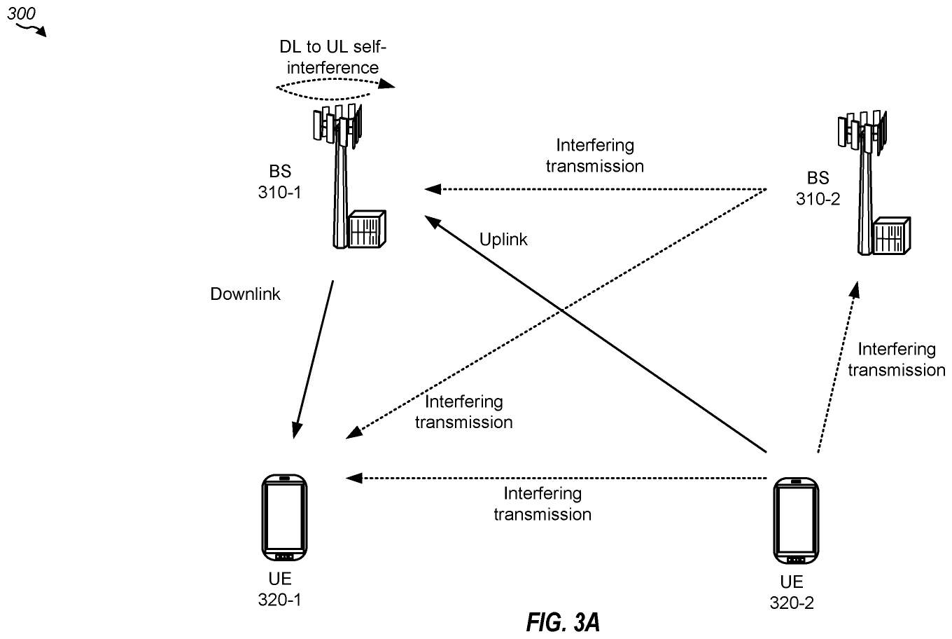

FIGS. 3A and 3B illustrate examples of full-duplex communication modes. In FIG. 3A, full-duplex base station and half-duplex UE operations are shown, and in FIG. 3B, full-duplex base station and full-duplex UE operations are shown. Full-duplex operation corresponds to transmitting and/or receiving data via multiple antennas at the same time. For example, a full-duplex node may concurrently transmit and receive data in a particular time division duplex (TDD) band. Half-duplex operation corresponds to transmitting or receiving data via a single antenna at a particular time.

FIGS. 3A and 3B depict interference caused from full-duplex operations. To illustrate, external interference and self-interference may be caused during full-duplex operations. External interference is caused from external sources, such as a from a nearby UE or base station. Self-interference is caused by the device. Self-interference may be caused by leakage, such as when transmitting energy from a transmitting antenna is received by receiving antenna directly or indirectly (e.g., by reflection).

In FIGS. 3A and 3B, multiple transmit-receive points (TRPs) are illustrated, such as a first TRP (TRP1) and a second TRP (TRP2). The first and second TRPs may include or correspond to the same base station, such as the same gNB, or to different base stations. In FIG. 3A, the first TRP may include or correspond to base station (BS) 310-1, and in FIG. 3B, the first TRP may include or correspond to BS 340-1. In FIG. 3A, the second TRP may include or correspond to BS 310-2, and in FIB. 3B, the second TRP may include or correspond to BS 340-2. In FIGS. 3A and 3B, the first TRP (TRP1) may be operating in the same frequency band or in different frequency bands. For example, the first TRP (TRP1) may be operating in a first frequency band, such as FR 4 or 60 GHz, and the second TRP (TRP2) may be operating in a second frequency band, such as FR 2 or 28 GHz.

Additionally, multiple UEs are illustrated in FIGS. 3A and 3B, such as a first UE (UE1) and a second UE (UE2). In FIG. 3A, the first UE may include or correspond to UE 320-1, and in FIG. 3B, the first UE may include or correspond to UE 350-1. In FIG. 3A, the second UE may include or correspond to UE 320-2, and in FIG. 3B, the second UE may include or correspond to UE 350-2. In some implementations, the UE is a full-duplex capable UE with multiple antenna module. FIGS. 3A and 3B further depict signal paths between the TRPs and the UEs.

Referring to FIG. 3A, FIG. 3A illustrates an example diagram 300 for a first type of full-duplex communication. In the example of FIG. 3A, the first TRP (TRP1) performs full-duplex communications and the UEs perform half-duplex communications. Referring to FIG. 3A, the diagram 300 illustrates two signal paths (beam paths) between the TRPs and the UEs and example interference. In the example illustrated in FIG. 3A, the first TRP (TRP1) transmits downlink data via a first signal path to the first UE (UE1) and the first TRP (TRP1) receives uplink data via a second signal path from the second UE (UE2). The first TRP and UE experience interference. For example, the first TRP experiences self-interference from simultaneously transmitting and receiving. Additionally, devices receive interference caused by other nearby devices. For example, operations of the second TRP may cause interference at all other nodes, such as the first UE and first TRP as illustrated in FIG. 3A. Additionally, the transmission of uplink data by the second UE may cause interference at the second TRP.

Referring to FIG. 3B, FIG. 3B illustrates an example diagram 310 for a second type of full-duplex communication. In the example of FIG. 3B, the TRPs and the UEs both perform full-duplex communications. Referring to FIG. 3B, the diagram 310 illustrates two signal paths (beam paths) between the TRPs and the UEs and example interference. In the example illustrated in FIG. 3B, the first TRP (TRP1) transmits downlink data via a first signal path to the first UE (UE1) and the first TRP (TRP1) receives uplink data via a second signal path from the first UE (UE1). Additionally, the second TRP (TRP2) transmits downlink data via a third signal path to the second UE (UE2) and the second TRP (TRP2) receives uplink data via a fourth signal path from the second UE (UE2). The first TRP experiences interference. For example, the first TRP experiences self-interference from simultaneously transmitting and receiving and from the operations of the second TRP and UE. The first UE also experiences interference, such as self-interference from simultaneously transmitting and receiving and from the operations of the second TRP and UE. Additionally, other devices may receive interference caused by the operation other nearby devices, as described with reference to FIG. 3A.

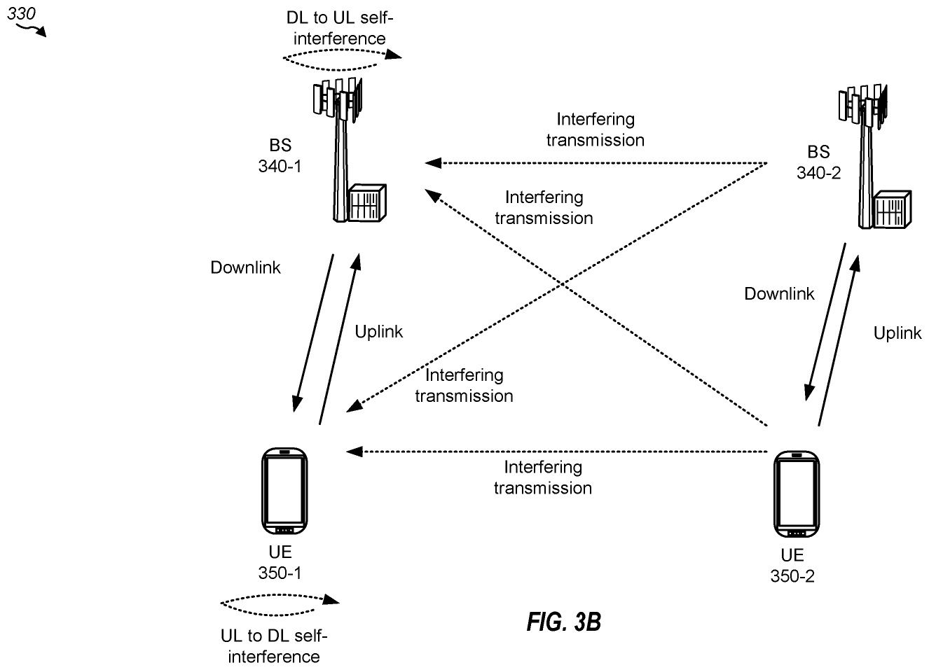

FIGS. 4A, 4B, and 4C illustrate examples of allocating resources for full-duplex communication operations. In FIGS. 4A and 4B, in-band full-duplex (IBFD) operations are shown, and in FIG. 4C sub-band full-duplex operations are shown. In-band full-duplex (IBFD) operation corresponds to transmitting and receiving on the same time and frequency resources. As shown in diagrams 400 and 410 of FIGS. 4A and 4B, the downlink and uplink resources share the same time and frequency resources. The downlink and uplink resources may fully or partially overlap, as shown in FIGS. 4A and 4B respectively. Sub-band full-duplex operation, often referred to as frequency division duplexing (FDD) or flexible duplex, corresponds to transmitting and receiving data at the same time but on different frequency resources. As shown in diagram 420 of FIG. 4C, the downlink resource is separate from the uplink resource by a relatively “thin” guard band. The guard band in FIG. 4C is enlarged for illustrative purposes. The guard band is what generally distinguishes SBFD from paired spectrum (e.g., IBFD) in current wireless standard specifications.

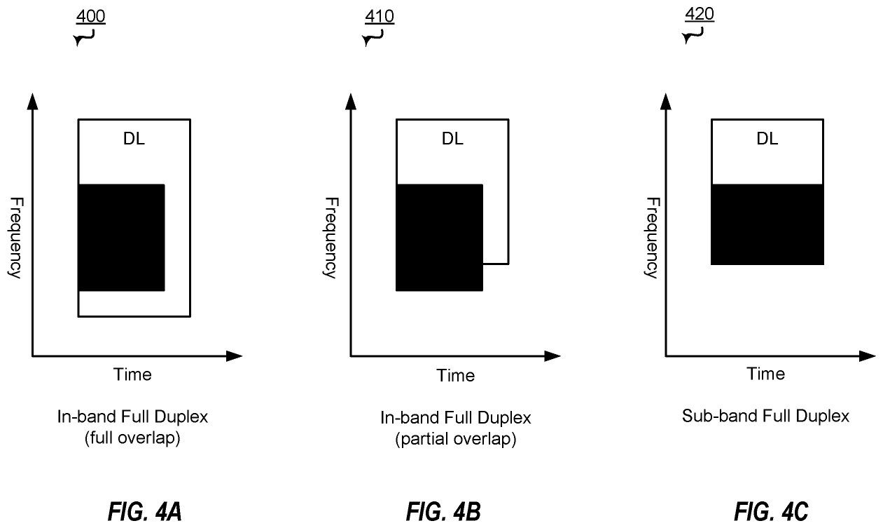

FIG. 5 illustrates an example 500 of division of an active bandwidth part (BWP) into multiple resource bandwidths (BWs). An active BWP may span multiple contiguous sub-bands (e.g., one or more frequency bands). The active BWP may be divided into multiple different resource BWs spanning a portion (or an entirety) of the frequency range spanned by the active BWP. In FIG. 5, the active BWP is divided into four resource BWs: a first resource BW (“Resource BW (1)”), a second resource BW (“Resource BW (2)”), a third resource BW (“Resource BW (3)”), and a fourth resource BW (“Resource BW (4)”). Although four resource BWs are shown, in other implementations, the active BWP may be divided into fewer than four or more than four resource BWs.

Some resource BWs may span an entirety of the active BWP, and other resource BWs span only a portion of the active BWP. For example, in FIG. 5, the first resource BW spans an entirety of the active BWP, and the second, third, and fourth resource BWs span only a corresponding portion of the active resource BWP. Additionally, some resource BWs may span a contiguous set of sub-bands (e.g., one or more contiguous sub-bands), and other resource BWs may span one or multiple disjoint sub-bands (e.g., disjoint sub-bands may be frequency sub-bands spaced apart in time or frequency). For example, in FIG. 5, the second resource BW and the fourth resource BW each span a contiguous set of sub-bands with a common boundary (e.g., a first set of sub-bands 502 and a second set of sub-bands 504), and the third resource bandwidth spans multiple disjoint sub-bands with no common boundary (e.g., a third set of sub-bands 506 and the second set of sub-bands 504). As illustrated in FIG. 5, the contiguous sub-bands are not spaced apart and the disjointed sub-bands are spaced apart in frequency.

The resource BWs may be defined and configured by one or more radio resource control (RRC) messages. For example, a base station may transmit a RRC message indicating the resource BW configuration illustrated in FIG. 5 for the active BWP to a UE. The resource BW to be used by the UE may be indicated dynamically. For example, the base station may transmit an indicator of a selected resource BW to the UE, such as in downlink control information (DCI). Uplink (UL) and downlink (DL) channels may have different resource BW configurations. Additionally or alternatively, each resource BW may have “optimized” configurations for that resource BW, such as a resource block group (RBG) configuration. When UL and DL resources are defined in this manner (e.g., as in FIG. 5), UL and DL resources can be non-overlapping (e.g., a SBFD configuration) or partially overlapping (e.g., a IBFD configuration). Unlike BWP switching in current wireless communication standard specifications, which is defined with a switching delay of one or more slots when switching from one type of BWP to another type of BWP, switching between different resource BWs defined for the same active BWP as described with reference to FIG. 5 does not have a switching delay (e.g., a zero slot delay).

Aspects of the present disclosure provide systems, apparatus, methods, and computer-readable media for enabling allocation of and use of reference signals. For example, allocating and using a sounding reference signal (SRS). As a particular example, UEs may utilize SRSs for sub-band full duplex operation. A UE may be configured to perform concurrent downlink (DL) reception and uplink (UL) transmission (e.g., via different antenna panels or subsets of an antenna array). The sub-band full duplex operations may include in-band full duplex (IBFD) (e.g., operations in which the DL resources and the UL resources overlap in time and at least partially overlap in frequency) or sub-band frequency division duplex (FDD) (e.g., operations in which the DL resources and the UL resources overlap in time but not in frequency, also referred to herein as “flexible duplex”). The SRS may be allocated based on the allocation of frequency resources to the UL to support SRS transmission by a UE configured for sub-band full duplex operations.

In some implementations of discussed aspects (e.g., SBFD operations), a UE may be allocated multiple disjoint frequency resources (e.g., frequency sub-bands) for communications (e.g., UL, DL, SL, P2P, D2D, etc.). Disjoint frequency usage generally refers to using frequencies or frequency bands that do not overlap in the frequency domain (e.g., that do not include any resource blocks in common). In some UL communication scenarios, utilized disjoint frequencies may be separated in frequency by one or more frequency resources allocated for DL communication (e.g., to the UE or to another UE). For example, a component carrier (CC) BW in SBFD may be split in frequency between DL and UL, such that a UL band is allocated at both edges of the CC BW with the DL band in between.

Various techniques described herein enable allocation of an SRS to disjoint frequency resources of one or more resource bandwidths (BWs) to enable SRS transmission via a divided UL band. For example, a UE may receive, from a base station, an indicator that indicates an allocation of an SRS to multiple disjoint frequency resources (e.g., multiple disjoint sub-bands) of one or more resource BWs of a bandwidth part (BWP) (e.g., a subdivision of a carrier that has its own numerology and configuration). The UE may then transmit the SRS to the base station via the multiple disjoint frequency resources in accordance with the allocation of the SRS. For example, one or more SRS resources (e.g., a single SRS resource or a single SRS resource set) may be configured for each frequency resource of a resource BW of the BWP, with different frequency domain parameters for each frequency resource (e.g., sub-band).

In some implementations, one or more SRS resources may be allocated at the BWP level. For example, an active BWP may be divided into multiple resource BWs. This may include, for example, contiguous sub-bands or multiple disjoint sub-bands within the active BWP. The SRS may be allocated to overlap in frequency with a selected resource BW of the multiple resource BWs. For example, a UE may receive, from a network node, a configuration message indicating division of a BWP into multiple resource BWs. The UE may also receive, from the network node, an indication of an allocation of an SRS to the BWP and an indication of an active resource BW of the multiple resource BWs. The UE may transmit, to the network node, the SRS via one or more frequency resources that overlap between the active resource BW and the allocation of the SRS (e.g., via a portion of a single SRS resource or a single SRS resource set that overlaps with the active resource BW). Because the active resource BW may be a contiguous set of sub-bands or multiple disjoint sub-bands, the SRS may be allocated to a contiguous set of sub-bands or multiple disjoint sub-bands. Additionally or alternatively, if the network node is a base station, division of the active BWP into multiple resource BWs may include division into one or more DL resource BWs and one or more UL resource bandwidths. Alternatively, the network node may be a second UE, and the resource BWs may be allocated for a sidelink (SL) between the UE and the second UE.

Particular implementations of the subject matter described in this disclosure can be implemented to realize one or more of the following potential advantages and/or benefits. In some aspects, the present disclosure provides techniques for enabling allocation of an SRS to multiple disjoint sub-bands. The SRS may be allocated via radio resource control (RRC) configuration, which may require minimal modifications to legacy wireless communication systems. Alternatively, the SRS may be allocated based on selection of a BW within an active BWP (e.g., at the BWP level). This type of SRS allocation may have more flexibility for multiplexing and configuring communications by multiple UEs, as well as enabling communications with different parameters. The above-described SRS allocation techniques may be used to perform SRS transmissions by UEs configured to perform full duplex operations (e.g., IBFD or SBFD operations) or half duplex operations.

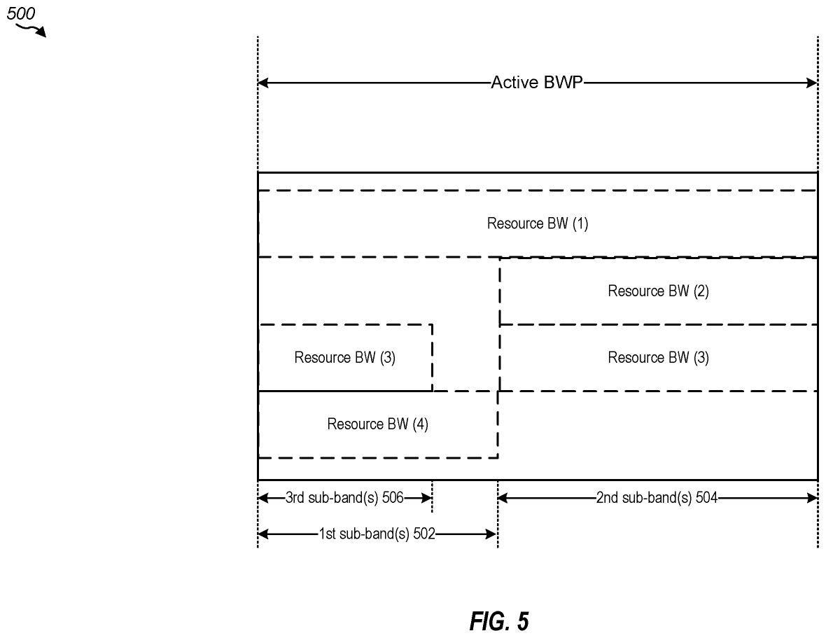

FIG. 6 is a block diagram of an example wireless communications system 600 configured to allocate an SRS resource to multiple disjoint frequency resources of one or more resource BWs according to some aspects. In some implementations, wireless communications system 600 may implement aspects of wireless network 100. Wireless communications system 600 includes UE 115 and a network entity 650. Network entity 650 may include or correspond to a base station, such as base station 105, a network, a network core, or another network device, as illustrative, non-limiting examples. In some implementations, the operations described with reference to network entity 650 may be performed by one or more other electronic/communication devices, such as another UE (e.g., a peer) or a scheduling entity. Although one UE 115 and one network entity 650 are illustrated, in some other implementations, wireless communications system 600 may generally include multiple UEs 115, and may include more than one network entity 650.

UE 115 can include a variety of components (such as structural, hardware components) used for carrying out one or more functions described herein. For example, these components can include a processor 602, a memory 604, antenna panels 610, a transmitter 612, and a receiver 614. Processor 602 may be configured to execute instructions stored at memory 604 to perform the operations described herein. In some implementations, processor 602 includes or corresponds to controller/processor 280, and memory 604 includes or corresponds to memory 282.

In some implementations, memory 604 may be configured to store a group of Zadoff Chu (ZC) sequences 606. For example, group of ZC sequences 606 may include multiple mathematical sequences that may be applied to communications from, or to, network entities to reduce inter-cell interference. In some implementations, group of ZC sequences 606 may include a respective group of ZC sequences for each network entity with which UE 115 is associated, and each group of ZC sequences may include ZC sequences for different sub-bands (e.g., frequency resources) allocated to communications with the corresponding network entity.

Antenna panels 610 may be configured to transmit signals, to receive signals, or both, from one or more other devices, such as network entity 650. In some implementations, UE 115 is configured to perform full duplex operations such that a first antenna panel of antenna panels 610 is configured to receive signals on the DL from network entity 650 concurrently with a second antenna panel of antenna panels 610 transmitting signals on the UL to network entity 650. As used herein, receiving and transmitting concurrently refers to receipt of signals at least partially overlapping in time with transmission of signals. Antenna panels 610 may be configured to support IBFD communications (e.g., DL communications that overlap in time with UL communications and that at least partially overlap in frequency) or SBFD communications (e.g., DL communications that overlap in time with UL communications but do not overlap in frequency), as described with reference to FIGS. 4A-4C. In some implementations, antenna panels 610 may include or correspond to (or be replaced with) an antenna array including a plurality of antennas, and the first antenna panel and the second antenna panel may include or correspond to a first subset of the antenna array and a second subset of the antenna array.

Transmitter 612 is configured to transmit reference signals, control information, and data to one or more other devices, and receiver 614 is configured to receive reference signals, synchronization signals, control information, and data from one or more other devices. For example, transmitter 612 may transmit signaling, control information, and data, and receiver 614 may receive signaling, control information, and data, via a network, such as a wired network, a wireless network, or a combination thereof. For example, UE 115 may be configured to transmit or receive signaling, control information, and data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 612 and receiver 614 may be integrated in a transceiver. Additionally, or alternatively, transmitter 612, receiver 614, or both may include and correspond to one or more components of UE 115 described with reference to FIG. 2.

Network entity 650 can include a variety of components (such as structural, hardware components) used for carrying out one or more functions described herein. For example, these components can include a processor 652, a memory 654, a transmitter 656, and a receiver 658. Processor 652 may be configured to execute instructions stored at memory 654 to perform the operations described herein. In some implementations, processor 652 includes or corresponds to controller/processor 240, and memory 654 includes or corresponds to memory 242.

Transmitter 656 is configured to transmit reference signals, synchronization signals, control information, and data to one or more other devices, and receiver 658 is configured to receive reference signals, control information, and data from one or more other devices. For example, transmitter 656 may transmit signaling, control information, and data, and receiver 658 may receive signaling, control information, and data, via a network, such as a wired network, a wireless network, or a combination thereof. For example, network entity 650 may be configured to transmit or receive data via a direct device-to-device connection, a LAN, a WAN, a modem-to-modem connection, the Internet, intranet, extranet, cable transmission system, cellular communication network, any combination of the above, or any other communications network now known or later developed within which permits two or more electronic devices to communicate. In some implementations, transmitter 656 and receiver 658 may be integrated in a transceiver. Additionally, or alternatively, transmitter 656, receiver 658 or both may include and correspond to one or more components of base station 105 described with reference to FIG. 2.

In some implementations, wireless communications system 600 implements a 5G New Radio (NR) network. For example, wireless communications system 600 may include multiple 5G-capable UEs 115 and multiple 5G-capable network entities 650, such as UEs and network entities configured to operate in accordance with a 5G NR network protocol such as that defined by the 3GPP.

During operation of the wireless communications system 600, UE 115 may be configured to perform SBFD operations, as described with reference to FIG. 4C, half duplex operations, or IBFD operations where DL resources overlap at least partially with one or more UL resources. For example, a first antenna panel of antenna panels 610 (or a first subset of an antenna array) may be configured to receive DL signals via a first portion that overlap in time with UL signals transmitted by a second antenna panel of antenna panels 610 (or a second subset of the antenna array), but that do not overlap in frequency. Alternatively, antenna panels 610 may be configured to transmit UL signals that overlap in time, but not in frequency, with DL signals transmitted to another UE. Alternatively, antenna panels 610 may be configured to transmit UL signals that overlap in time and at least partially in frequency with DL signals received by another antenna panel or DL signals for another UE.

Network entity 650 may allocate, within a CC, multiple disjoint (e.g., non-contiguous) resource BWs (e.g., one or more sub-bands) for UL communications from UE 115 to network entity 650. For example, network entity 650 may allocate a first set of slots (e.g., time resources) to UL communications and one or more resource BWs (e.g., sets of frequency resources) to UL communications by UE 115. In some implementations, network entity 650 may define a BWP (e.g., a contiguous set of physical resource blocks (PRBs), a frequency range, a frequency band, multiple contiguous sub-bands, or the like) associated with the CC for communication between UE 115 and network entity 650, and the multiple disjoint resource BWs may be within the BWP. At least one resource BW of the one or more resource BWs may include a first frequency resource (e.g., a first sub-band), and a non-contiguous second frequency resource (e.g., a second sub-band). Network entity 650 may generate and transmit UL resource allocation 670 to UE 115. UL resource allocation 670 may indicate the above-described allocation of resource BWs, such as within the BWP associated with the CC, to UL communications. In some implementations, UL resource allocation 670 may be included in and/or indicated by DCI transmitted by network entity 650 to UE 115. In some other implementations, UL resource allocation 670 is included in and/or indicated by a different type of message, such as an RRC message. Allocation of DL resources may be similarly determined and communicated to UE 115. In some implementations, an intervening resource BW (e.g., a third resource BW between the first resource BW and the second resource BW) may be allocated to DL communications.

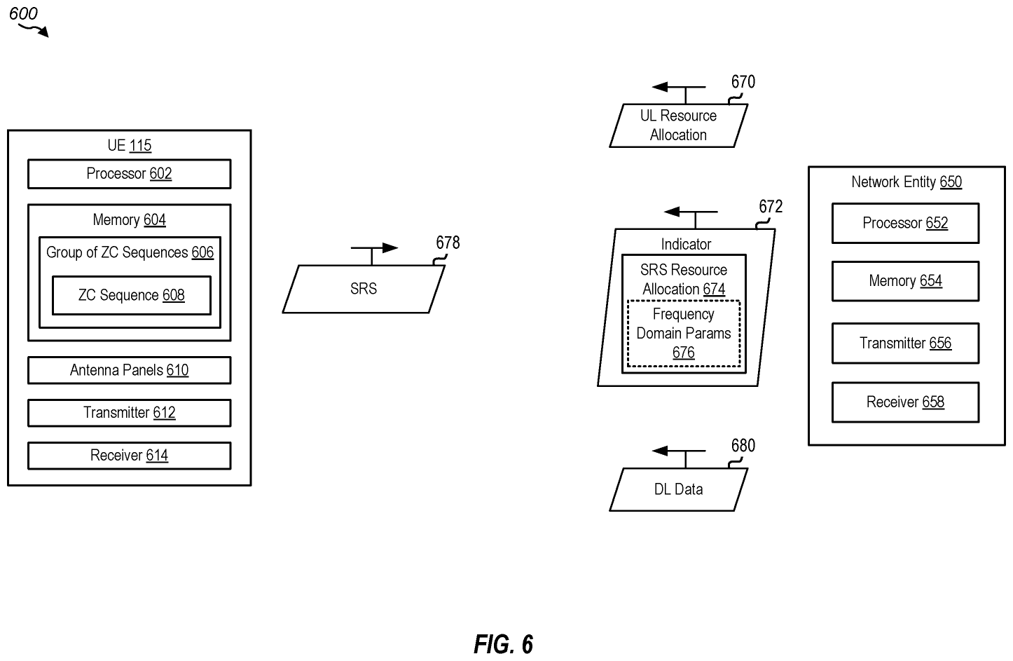

After transmitting UL resource allocation 670, network entity 650 may allocate, within the BWP, an SRS to multiple disjoint frequency resources of one or more resource BWs. As used herein, allocating an SRS to one or more frequency resources may also be referred to as designating the one or more frequency resources as SRS resources (e.g., allocating one or more SRS resources). For example, network entity 650 may determine SRS resource allocation 674 indicating the allocation of an SRS resource to multiple disjoint frequency resources of one or more resource BWs. The one or more resource BWs (and the BWP) may correspond to one or more frequency resources allocated for UL data and signal transmissions from UE 115 to network entity 650. The multiple disjoint frequency resources to which the SRS resource is allocated may overlap with the one or more resource BWs to which the UL communications are allocated. For example, the multiple disjoint frequency resources to which the SRS resource is allocated may include one or more portions (e.g., one or more resource blocks (RBs)) of the one or more resource BWs to which the UL communications are allocated. Unlike as defined in one or more wireless communication standard specifications, such as one or more 3GPP standard specifications, the SRS resource (e.g., a single SRS resource or a single SRS resource set) is allocated to disjoint (e.g., non-contiguous) frequency resources of one or more resource BWs (e.g., within a BWP of a CC). An example of allocating an SRS resource to multiple disjoint frequency resources is further described with reference to FIG. 7A.

Network entity 650 may generate indicator 672 that indicates SRS resource allocation 674. Network entity 650 may transmit, and UE 115 may receive, indicator 672. In some implementations, indicator 672 is included in a RRC configuration message that is transmitted to UE 115. In some other implementations, indicator 672 may be included in another type of message that is transmitted to UE 115.

In some implementations, SRS resource allocation 674 is indicated by frequency domain parameters 676. For example, if indicator 672 is included in a RRC configuration message, the RRC configuration message may further include frequency domain parameters 676. Frequency domain parameters 676 may be similar to frequency domain parameters of RRC configuration messages defined for an SRS resource allocation in one or more wireless communication standard specifications, except that frequency domain parameters 676 may include a set of frequency domain parameters associated with each frequency resource of the multiple disjoint frequency resources indicated in SRS resource allocation 674 (as compared to one set of frequency domain parameters associated with a contiguous set of frequency resources as described in the one or more wireless communication standard specifications). For example, if SRS resource allocation 674 indicates that the SRS resource is allocated to three disjoint frequency resources (e.g., a first frequency resource, a second frequency resource, and a third frequency resource), frequency domain parameters 676 may include first frequency domain parameters associated with the first frequency resource, second frequency domain parameters associated with the second frequency resource, and third frequency domain parameters associated with the third frequency resource. Because frequency domain parameters 676 include parameters associated with each frequency resource included in SRS resource allocation 674, the SRS resource (or SRS resources of the SRS resource set) are configured per each frequency resource or per each resource BW.

Each set of frequency domain parameters may include at least two parameters: a position parameter (e.g., “freqDomainPosition”) that indicates a starting resource block group (RBG) of the corresponding frequency resource and a shift parameter (e.g., “freqDomainShift”) that indicates a part (e.g., a resource block (RB), a frequency, or the like) within the RBG of the frequency resource that is a starting position of the SRS signal. In some implementations, one or more sets of frequency domain parameters include a frequency hopping parameter (e.g., “freqHopping”) that indicates a frequency hopping pattern within a corresponding frequency resource (or resource BW) for the one or more SRS resources. Thus, in at least some implementations, a SRS may frequency hop within one or more frequency resources or resource BWs allocated to the one or more SRS resources.

In some implementations, SRS resource allocation 674 may be configured according to the following pseudocode:

| | |
|---|---|
| SRS-Resource ::= | SEQUENCE { |

| | |
|---|---|
| srs-ResourceId | SRS-ResourceID |
| nrofSRS-Ports | ENUMERATED {port1, ports2, ports4}, |
| ptrs-PortIndex | ENUMERATED {n0, n1 } |
| transmissionComb | CHOICE { |

| | |
|---|---|
| n2 | SEQUENCE { |

| | |
|---|---|
| combOffset-n2 | INTEGER {0..1}, |

| | |
|---|---|
| cyclicShift-n2 | INTEGER {0..7} |

| }; | |
|---|---|
| n4 | SEQUENCE { |

| | |
|---|---|
| combOffset-n4 | INTEGER {0..3}, |

| | |
|---|---|
| cyclicShift-n4 | INTEGER {0..11} |

}

| }, | |
|---|---|
| resourceMapping | SEQUENCE { |

| | |
|---|---|
| startPosition | INTEGER {0..5}, |
| nrofSymbols | ENUMERATED {n1, n2, n4} |

| | |
|---|---|
| repetitionFactor | ENUMERATED {n1, n2, n4} |

| }, | |
|---|---|
| freqDomainPosition | sequence (size (1..NumSubBand)) of |

INTEGER (0..67),

| | |
|---|---|
| freqDomainShift | sequence (size (1..NumSubBand of |

INTEGER (0..268),

| | |
|---|---|
| freqDomainHopping | SEQUENCE { |

| | |
|---|---|
| c-SRS | INTEGER (0..63), |
| b-SRS | INTEGER (0..3), |
| b-hop | INTEGER (0..3) |

| }, | |
|---|---|
| groupOrSequenceHopping | ENUMERATED {neither, |

groupHopping, sequenceHopping},

After receiving indicator 672, UE 115 may transmit SRS 678 via the multiple disjoint frequency resources in accordance with the allocation of the SRS resource (e.g., SRS resource allocation 674 included in indicator 672). In some implementations, the SRS resource includes a single SRS resource. For example, SRS 678 may include a single SRS transmitted via the multiple disjoint frequency resources. In some other implementations, the SRS resource includes a single set of SRS resources. For example, SRS 678 may include a single set of SRSs transmitted via the multiple disjoint frequency resources. In this manner, only a single SRS resource (or a single set of SRS resources) may be sent at certain symbol(s) (e.g., there is no frequency division multiplexing (FDM) between different SRS resources).

In some implementations, UE 115 may receive DL data 680 from network entity 650 via at least one intervening frequency resource between the multiple disjoint frequency resources. For example, as described above, the multiple disjoint frequency resources may include a first frequency resource and a second frequency resource allocated to UL communications, and the at least one intervening frequency resource may include a third frequency resource between the first frequency resource and the second frequency resource. The multiple disjoint frequency resources (e.g., the first frequency resource and the second frequency resource) may include multiple non-contiguous frequency sub-bands that do not overlap with at least one frequency sub-band corresponding to the at least one intervening frequency resource (e.g., the third frequency resource). In some implementations, a guard band may be allocated between one of the multiple disjoint frequency resources and the at least one intervening frequency resource, such as a first guard band allocated between the first frequency resource and the third frequency resource, and a second guard band allocated between the third frequency resource and the second frequency resource, as further described with reference to FIG. 4C. Alternatively, if UE 115 is configured for half duplex operations, the at least one intervening frequency resource may be allocated to DL transmissions by network entity 650 to another UE.

In some implementations, UE 115 may receive DL data 680 from network entity 650 via at least one overlapping frequency resource with one or more of the multiple disjoint frequency resources. For example, as described above, the multiple disjoint frequency resources may include a first frequency resource and a second frequency resource allocated to UL communications, and the at least one overlapping frequency resource may include a third frequency resource that overlaps with at least a portion of the first frequency resource, at least a portion of the second frequency resource, or at least a portion of both frequency resources. The multiple disjoint frequency resources (e.g., the first frequency resource and the second frequency resource) may include multiple non-contiguous frequency sub-bands that may overlap with at least one frequency sub-band corresponding to the at least one overlapping frequency resource (e.g., the third frequency resource).

In some implementations, SRS 678 is transmitted via a first antenna panel of antenna panels 610, and DL data 680 is received via a second antenna panel of antenna panels 610. For example, a first antenna panel of antenna panels 610 (or a first subset of a plurality of antennas/antenna array of UE 115) may be configured to transmit signals on the UL, such as SRS 678, and a second antenna panel of antenna panels 610 (e.g., a second subset of the plurality of antennas/antenna array of UE 115) may be configured to receive signals on the DL, such as DL data 680.

In some implementations, UE 115 may transmit SRS 678 during the same set of symbols via the multiple disjoint frequency resources, such that the multiple disjoint frequency resources are associated with one or more overlapping time resources (e.g., symbols). For example, UE 115 may transmit SRS 678 via the first frequency resource during a set of symbols (e.g., a particular time period) in addition to transmitting SRS 678 via the second frequency resource during the same set of symbols (e.g., the same time period). In some such implementations, UE 115 may also receive DL data 680 during the same set of symbols (e.g., the same time period) as transmission of SRS 678.

In some implementations, UE 115 may select a corresponding ZC sequence for each frequency resource of the multiple disjoint frequency resources from the same group of ZC sequences. For example, UE 115 may select a corresponding ZC sequence from group of ZC sequences 606 stored at memory 604 for use in transmitting SRS 678 via each frequency resource of the multiple disjoint frequency resources indicated by indicator 672. Each ZC sequence of group of ZC sequences 606 may be associated with the same first variable value and with a different second variable value. For example, each ZC sequence of group of ZC sequences 606 may be associated with network entity 650 (as indicated by having the same first variable value) and may be associated with a different frequency resource (as indicated by having different second variable values). Each portion of SRS 678 transmitted via a different frequency resource may be encoded or modulated based on a different ZC sequence. For example, UE 115 may encode or modulate a first portion of SRS 678 based on ZC sequence 608 corresponding to network entity 650 and to a first frequency resource of the multiple disjoint frequency resources.

As described with reference to FIG. 6, the present disclosure provides techniques for enabling allocation of an SRS resource to multiple disjoint sub-bands. The SRS resource may be allocated via RRC configuration, which may require minimal modifications to legacy wireless communication systems. For example, instead of including one set of frequency domain parameters indicating allocation of the SRS resource (e.g., to a contiguous set of frequency resources), the SRS resource may be allocated to multiple disjoint frequency resources by including a set of frequency domain parameters corresponding to each frequency resource in the RRC configuration. In this manner, SRS transmissions may be enabled for a UE configured to perform SBFD operations or half duplex operations via multiple disjoint sub-bands without necessitating many changes to current SRS allocation procedures.

FIGS. 7A-7C illustrate examples of allocation of UL, DL, and SRS resources to SBFD or IBFD configured UEs according to some aspects. FIG. 7A illustrates an example 700 of allocation of UL, DL, and SRS resources to a SBFD configured UE according to some aspects. For example, the allocation of resources may include or correspond to UL resource allocation 670 and SRS resource allocation 674 for UE 115 of FIG. 6.

As shown in FIG. 7A, DL resources may be allocated to multiple disjoint frequency resources, and UL resources may be allocated to an intervening frequency resource. Such allocation may be for “DL-heavy” UEs (or periods of time) because more frequency resources are allocated to DL communications than are allocated to UL communications. For example, during a first set of symbols (e.g., a first time period), a second set of symbols, and a third set of symbols, DL resources may be allocated to a first frequency resource and a second frequency resource, and UL resources may be allocated to a third frequency resource separating the first frequency resource from the second frequency resource. In some implementations, the first frequency resource and the third frequency resource may be separated by a first guard band, and the second frequency resource and the third frequency resource may be separated by a second guard band, as described with reference to FIG. 4C. The DL resources and the UL resources may be allocated to different communications at different times during the corresponding time period (e.g., set of symbols). To illustrate, an initial portion (e.g., during one or more initial symbols of the set of symbols) of each DL frequency resource may be allocated to downlink control information (DCI), and a remaining portion (e.g., during the remainder of the set of symbols) may be allocated to DL data. Similarly, a first portion (e.g., during most of the set of symbols) of each UL frequency resource may be allocated to a physical uplink control channel (PUSCH), and a remaining portion (e.g., during the remainder of the set of symbols) may be allocated to UL data.

As shown in FIG. 7A, UL resources may also be allocated to multiple disjoint frequency resources, and DL resources may be allocated to an intervening frequency resource. Such allocation may be for “UL-heavy” UEs (or periods of time) because more frequency resources are allocated to UL communications than are allocated to DL communications. For example, during a fourth set of symbols (e.g., a fourth time period), UL resources may be allocated to a first frequency resource and a second frequency resource, and DL resources may be allocated to a third frequency resource separating the first frequency resource from the second frequency resource. In some implementations, the first frequency resource and the third frequency resource may be separated by a first guard band, and the second frequency resource and the third frequency resource may be separated by a second guard band, as described with reference to FIG. 4C. The DL resources and the UL resources may be allocated to different communications at different times during the corresponding time period (e.g., set of symbols). To illustrate, an initial portion (e.g., during one or more initial symbols of the set of symbols) of the DL frequency resource may be allocated to DCI, and a remaining portion (e.g., during the remainder of the set of symbols) may be allocated to DL data. Similarly, a first portion (e.g., during most of the set of symbols) of each UL frequency resource may be allocated to a PUSCH, and a remaining portion (e.g., during the remainder of the set of symbols) may be allocated to a single SRS resource, as described with reference to FIG. 6.

Thus, as shown in FIG. 7A, an SRS resource may be allocated to multiple disjoint frequency resources of one or more resource BWs, such as one or more resource BWs within a BWP, as a non-limiting example. Although the SRS resource illustrated in FIG. 7A is illustrated as overlapping an entirety of the UL frequency resources, in other implementations, the SRS resource may only overlap a portion of the corresponding UL frequency resources. Additionally or alternatively, the SRS resource may frequency hop across the UL frequency resources or resource BWs, as described with reference to FIG. 6.

FIG. 7B illustrates an example 710 of allocation of UL, DL, and SRS resources to an IBFD configured UE according to some aspects. For example, the allocation of resources may include or correspond to UL resource allocation 670 and SRS resource allocation 674 for UE 115 of FIG. 6. As described with reference to FIG. 7A, the UL resources and the SRS resources may be allocated to multiple disjoint frequency resources of one or more resource BWs. However, in FIG. 7B, DL resources are allocated to resources that at least partially overlap each of the UL resources. For example, UL resources and SRS resources may be allocated to a first frequency resource and a second frequency resource, and DL resources may be allocated to a third frequency resource that overlaps a portion of the first frequency resource and a portion of the second frequency resource. As shown in FIG. 7B, the DL resources may not overlap in time the portion of the UL resources allocated to the SRS.

FIG. 7C illustrates an example 720 of allocation of UL, DL, and SRS resources to an IBFD configured UE according to some aspects. For example, the allocation of resources may include or correspond to UL resource allocation 670 and SRS resource allocation 674 for UE 115 of FIG. 6. As described with reference to FIG. 7A, the UL resources and the SRS resources may be allocated to multiple disjoint frequency resources of one or more resource BWs. However, in FIG. 7C, DL resources are allocated to resources that at least partially overlap one of the UL resources. For example, UL resources and SRS resources may be allocated to a first frequency resource and a second frequency resource, and DL resources may be allocated to a third frequency resource that overlaps a portion of the first frequency resource, but does not overlay any of the second frequency resource. In other implementations, the third frequency resource may overlap a portion of the second frequency resource, but not any portion of the first frequency resource. As shown in FIG. 7C, the DL resources may not overlap in time the portion of the UL resources allocated to the SRS.

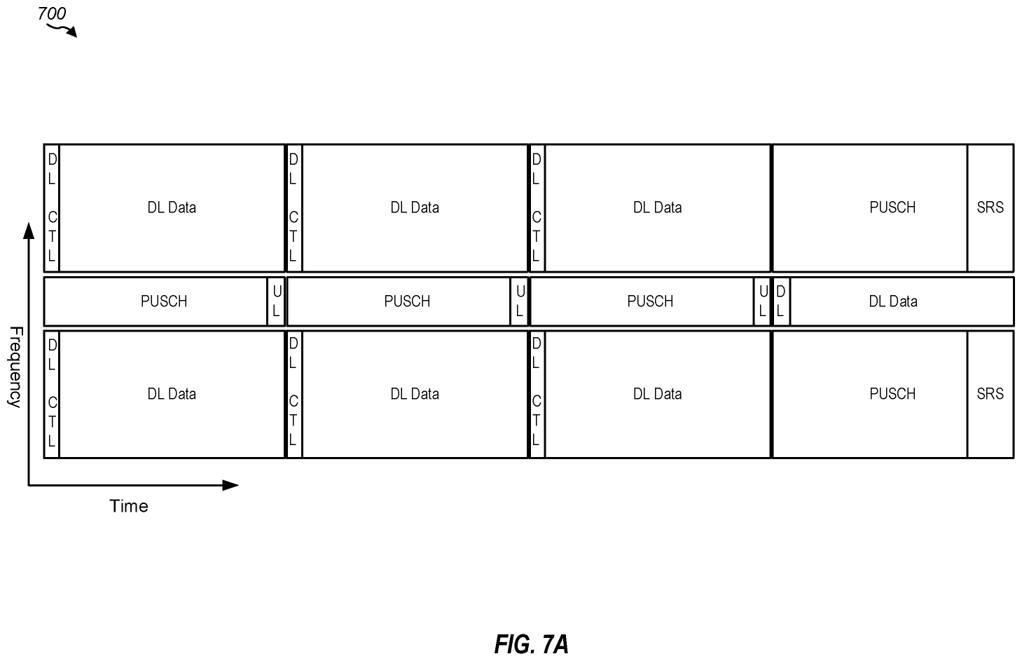

Referring to FIG. 8, an example wireless communications system 800 configured to allocate SRS resources based on an active BWP according to some aspects is shown. Such allocation may be referred to as allocating the SRS resource at the BWP level. Wireless communications system 800 may include UE 115 and network node 850. Network node 850 may include or correspond to a network entity, such as a base station, a network, a network core, or another network device, or to a second UE. In some implementations, the operations described with reference to network node 850 may be performed by one or more other electronic/communication devices, such as another UE (e.g., a peer) or a scheduling entity. Although one UE 115 and one network node 850 are illustrated, in some other implementations, wireless communications system 800 may generally include multiple UEs 115, and may include more than one network node 850.

UE 115 may include a processor 802, a memory 804, antenna panels 810, a transmitter 812, and a receiver 814, which may include or correspond to processor 602, memory 604, antenna panels 610, transmitter 612, and receiver 614 of FIG. 6, respectively. Network node 850 may include a processor 852, a memory 854, a transmitter 856, and a receiver 858, which may include or correspond to processor 652, memory 654, transmitter 656, and receiver 658 of FIG. 6, respectively. As one difference from FIG. 6, in FIG. 8, memory 804 may be configured to store SRS sequence 806. SRS sequence 806 may include or correspond to a mathematical sequence that, when used to transmit a SRS, maintains orthogonality when different portions of the SRS are transmitted via different disjoint frequency sub-bands.

During operation of wireless communications system 800, network node 850 may partition a BWP associated with a CC (or another allocation) into multiple resource BWs. For example, network node 850 may divide a BWP into multiple resource BWs including contiguous frequency sub-bands, non-contiguous frequency sub-bands, or both, as described with reference to FIG. 5. Network node may generate configuration message 870 that includes BWP partition 872 (e.g., an indication of the above-described division/partitioning of the BWP). Network node 850 may transmit, and UE 115 may receive, configuration message 870. In some implementations, configuration message 870 may be a RRC configuration message. In some such implementations, the RRC configuration message (e.g., configuration message 870) may further include a frequency hopping parameter that indicates a frequency hopping pattern for SRS resources within a resource BW, as described with reference to FIG. 6. In some other implementations, configuration message 870 may be a different type of message. Configuration message 870 may be transmitted at particular times by network node 850, such as during a handover or association process between UE 115 and network node 850.

Network node 850 may also allocate an SRS resource for UE 115. The SRS resource may be allocated at the BWP level. For example, network node 850 may allocate a SRS resource (e.g., a single SRS resource or a single SRS resource set) to the BWP (e.g., to the frequency resources comprising the BWP). Network node 850 may generate indicator 871 that indicates SRS resource 873 (e.g., the SRS resource allocated to the BWP). Network node 850 may transmit, and UE 115 may receive, indicator 871. In some implementations, indicator 871 may be included in an RRC message.

To enable UE 115 to perform communications with network node 850, network node 850 may assign an active resource BW of the multiple resource BWs included in BWP partition 872. For example, network node 850 may generate an indicator 874 that indicates an active resource BW 876 (e.g., a selected resource BW). In some implementations, indicator 874 may include an identifier associated with active resource BW 876. In other implementations, indicator 874 may include one or more other parameters associated with active resource BW 876 that enable identification of active resource BW 876 at UE 115, such as one or more starting RBs, one or more ending RBs, or the like. Network node 850 may transmit, and UE 115 may receive, indicator 874.

In some implementations, network node 850 includes or corresponds to a network entity, such as a base station. In some such implementations, active resource BW 876 is allocated for UL communications from UE 115 to network node 850, and indicator 874 may be included in DCI transmitted to UE 115. In some other implementations, network node 850 includes or corresponds to a second UE. In some such implementations, active resource BW 876 is allocated for SL communications from UE 115 to network node 850, and indicator 874 may be included in sidelink control information (SCI) transmitted to UE 115.

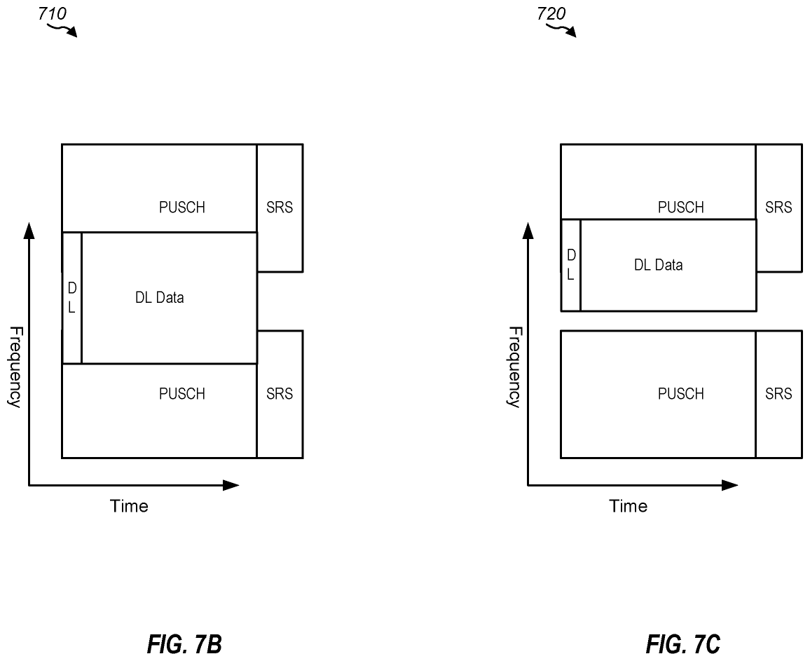

After receiving indicator 874, UE 115 may transmit SRS 878 to network node 850 via one or more frequency resources (e.g., frequency bands or sub-bands) that overlap between active resource BW 876 and SRS resource 873. Stated another way, UE 115 may transmit SRS 878 via one or more frequency resources of SRS resource 873 (e.g., corresponding to the BWP) that overlap in frequency with active resource BW 876, as further described with reference to FIG. 9. In some implementations, the SRS resource 873 includes a single SRS resource. For example, SRS 878 may include a single SRS transmitted via active frequency resource(s) that overlap with active resource BW 876. In some other implementations, SRS resource 873 includes a single set of SRS resources. For example, SRS 878 may include a single set of SRSs transmitted via frequency resource(s) that overlap with active resource BW 876.

In some implementations, active resource BW 876 includes at least two disjoint frequency sub-bands. For example, active resource BW 876 may include a first frequency sub-band that is non-contiguous with a second frequency sub-band, as described with reference to Resource BW (3) of FIG. 5. In such implementations, SRS 878 is transmitted via at least two disjoint frequency sub-bands. Alternatively, active resource BW 876 may include a single contiguous frequency sub-band (or multiple contiguous frequency sub-bands). For example, active resource BW 876 may include one or more contiguous frequency sub-bands, as described with reference to Resource BW (1) or to Resource BW (2) and Resource BW (4) of FIG. 5. In such implementations, SRS 878 is transmitted via one or more contiguous frequency sub-bands.

In some implementations, UE 115 may generate SRS 878 based on SRS sequence 806. SRS sequence 806 may include or correspond to a mathematical sequence that, when used to transmit a SRS, maintains orthogonality when different portions of the SRS are transmitted via different disjoint frequency sub-bands. In this manner, SRS sequence 806 may maintain orthogonality when a resource BW is “chopped” (e.g., separated into disjoint frequency sub-bands) or when the SRS frequency hops within a resource BW.

In some implementations, multiple active resource BWs may be assigned at the same time for different directions of communications. For example, active resource BW 876 may be assigned for communications from UE 115 to network node 850. Additionally, network node 850 may transmit an indicator 880 to UE 115. Indicator 880 may indicate a second active resource BW assigned to communications from network node 850 to UE 115. In some such implementations, active resource BW 876 and second active resource BW 882 at least partially overlap in time and in frequency. As a non-limiting example, active resource BW 876 may include or correspond to Resource BW (1) and second active resource BW 882 may include or correspond to Resource BW (3) of FIG. 5. In some other implementations, active resource BW 876 and second active resource BW 882 overlap at least partially in time but not in frequency. As a non-limiting example, active resource BW 876 may include or correspond to Resource BW (2) and second active resource BW 882 may include or correspond to Resource BW (4) of FIG. 5. In this manner, the allocation of resource BWs and SRS resources may support UEs configured for IBFD operations and UEs configured for SBFD operations.

In some implementations, during the same time period (e.g., during a set of slots), UE 115 may transmit SRS 878 via active resource BW 876 and receive data 884 from network node 850 via second active resource BW 882. In some implementations, network node 850 includes or corresponds to a base station (or other network entity), active resource BW 876 is allocated for one or more UL communications from UE 115 to network node 850, second active resource BW 882 is allocated for one or more DL communications from network node 850 to UE 115, and data 884 includes DL data. In such implementations, indicator 874 (and indicator 880) may be included in DCI transmitted by network node 850 to UE 115. Alternatively, network node 850 may include or correspond to a second UE, active resource BW 876 may be allocated for one or more SL communications from UE 115 to network node 850, second active resource BW 882 may be allocated for one or more SL communications from network node 850 to UE 115, and data 884 may include SL data. In such implementations, indicator 874 (and indicator 880) may be included in SCI transmitted by network node 850 to UE 115.

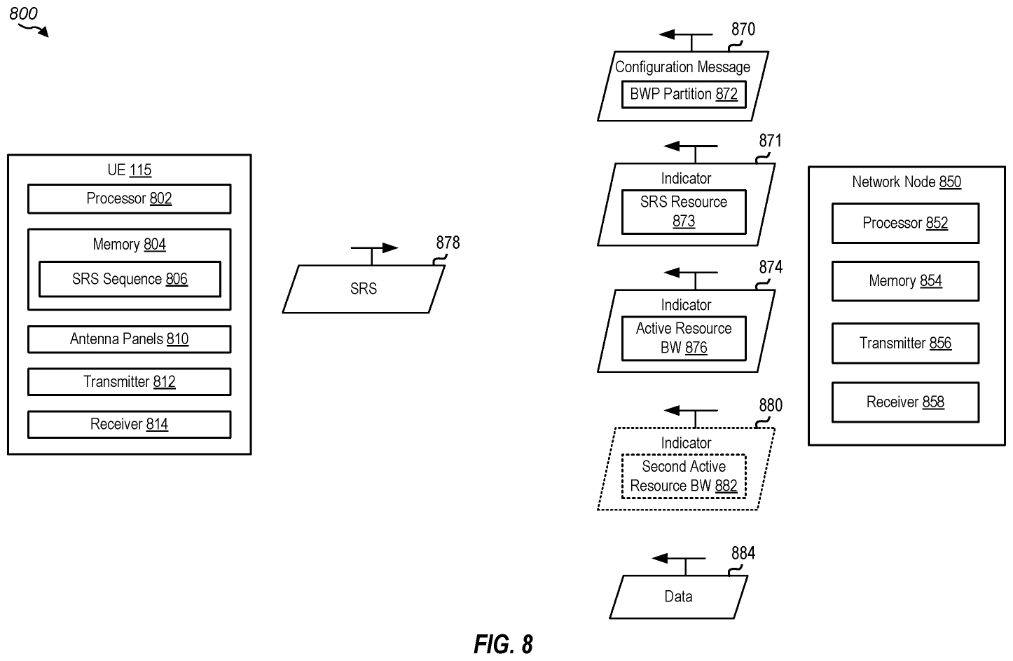

In some implementations, UE 115 may refrain from transmitting (e.g., omit or drop) a portion of SRS 878 if that portion will collide with transmission of a higher priority channel. For example, UE 115 may determine that a first portion of SRS resource 873 will collide with a channel transmitted via active resource BW 876. If the channel has a higher priority than SRS 878, UE 115 only transmits SRS 878 via a second portion of SRS resource 873 (corresponding to active resource BW 876). For example, if active resource BW 876 includes a first frequency sub-band and a second frequency sub-band, and UE 115 determines that SRS 878 will collide with a higher priority channel in the first frequency sub-band but not in the second frequency sub-band, then UE 115 may drop SRS 878 in the first frequency sub-band and only transmit SRS 878 via the second frequency sub-band. An example of dropping a portion of an SRS is further described with reference to FIG. 10. In some implementations, the higher priority channel may be a physical uplink control channel (PUCCH), a physical sidelink control channel (PSCCH), or a physical random access channel (PRACH).

As described with reference to FIG. 8, the present disclosure provides techniques for enabling allocation of an SRS resource at the BWP level. The SRS resource may be allocated based on selection of a resource BW within the BWP. The resource BW may be one or more contiguous frequency sub-bands or multiple disjoint frequency sub-bands. In this manner, SRS transmissions may be enabled for a UE configured to perform IBFD operations or SBFD operations. This type of SRS resource allocation may have more flexibility than other types of SRS resource allocation, such as multiplexing of multiple UEs, or enabling UEs to transmit SRSs using different combs or different cyclic shifts within different sub-bands. Additionally or alternatively, this type of SRS resource allocation may be particularly beneficial for use with SL communications between UEs to enable SRS transmission between UEs to facilitate channel estimation.

FIG. 9 illustrates an example 900 of allocation of SRS resources to a full duplex configured UE according to some aspects. For example, the allocation of SRS resources may include or correspond an allocation of SRS resources from network node 850 to UE 115 of FIG. 8.

An active BWP may be divided into multiple resource BWs. In FIG. 9, the active BWP is divided into a first resource BW (“Resource BW (1)”), a second resource BW (“Resource BW (2)”), a third resource BW (“Resource BW (3)”), and a fourth resource BW (“Resource BW (4)”), as described with reference to FIG. 5. As illustrated by the SRS resource below the active BWP in FIG. 9, SRS resource(s) may be allocated within the active BWP.

An SRS resource may be allocated at the BWP level, as described with reference to FIG. 8. The SRS transmitted by the UE may be transmitted via one or more frequency resources of the SRS resource (e.g., corresponding to the BWP) that overlap with an active resource BW. For example, as depicted by the SRS resources to the right of the active BWP in FIG. 9, if the first resource BW is selected, a portion of the SRS resource used to transmit the SRS overlaps (e.g., in frequency) with the first resource BW (e.g., the portion of the SRS resource spans the same one or more frequency sub-bands as the selected resource BW). Similarly, if the second resource BW, the third resource BW, or the fourth resource BW is selected, the portion of the SRS resource overlaps the second resource BW, the third resource BW, or the fourth resource BW, respectively.

In some implementations, the portion of the SRS resource may be an entirety of the SRS resource (e.g., may span an entirety of the active BWP). For example, the portion of the SRS resource overlapping the first resource BW spans an entirety of the active BWP (e.g., an entirety of the allocated SRS resource). Alternatively, the portion of the SRS resource may span one or more portions of the active BWP. For example, the portions of the SRS resource overlapping the second resource BW, the third resource BW, or the fourth resource BW span one or more portions of the active BWP (e.g., less than an entirety of the allocated SRS resource). In some implementations, the portion of SRS resource includes one or more contiguous frequency sub-bands. For example, the portions of the SRS resource overlapping the first resource BW or the second resource BW and the fourth resource BW span one or more contiguous frequency sub-bands. Alternatively, the portion of the SRS resource may include multiple disjoint frequency sub-bands. For example, the portion of the SRS resource overlapping the third resource BW spans two non-contiguous frequency sub-bands (e.g., corresponding to the third set of sub-bands 506 and the second set of sub-bands 504 of FIG. 5). Although the SRS resource portions are shown in FIG. 9 as overlapping an entirety of the corresponding resource BW, the SRS transmitted within the portion of the SRS resource may use only a sub-portion of the portion of the SRS resource. For example, an SRS may be configured to frequency hop within the portion of the SRS resource (e.g., within the selected resource BW). As described with reference to FIG. 8, the SRS may be transmitted using an SRS sequence that maintains orthogonality when chopped or hopping. For example, the SRS sequence may maintain orthogonality when transmitted via the portion of the SRS resource overlapping the third resource BW or when the SRS frequency hops within frequency resource(s) overlapping a selected resource BW.

FIG. 10 illustrates an example 1000 of configuring SRS resources based on detected collisions according to some aspects. For example, the operations described with reference to FIG. 10 may be performed by UE 115 of FIG. 8.

As described with reference to FIG. 9, an SRS resource (or a portion thereof) may overlap a selected resource BW of an active BWP. In FIG. 10, the selected resource BW is the third resource BW (“Resource BW (3)”) of FIG. 9. Accordingly, the SRS resource (or the portion thereof) includes a first frequency sub-band (or set of frequency sub-bands) and a second frequency sub-band (or set of frequency sub-bands). If one or more portions of an SRS resource are determined to overlap with a higher priority channel, the one or more portions of the SRS resource may be omitted or dropped, and the SRS is transmitted using the remainder of the SRS resource (or the portion thereof). For example, in FIG. 10, UE 115 may determine that the SRS resource will collide with a PUCCH resource in the second frequency sub-band. Based on this determination, UE 115 may drop the SRS from the second frequency sub-band and only transmit the SRS within the first frequency sub-band. Although the higher priority channel is depicted as a PUCCH in FIG. 10, any type of channel (or transmission) that has a higher priority than an SRS may cause UE 115 to drop the SRS from a portion of the SRS resource.

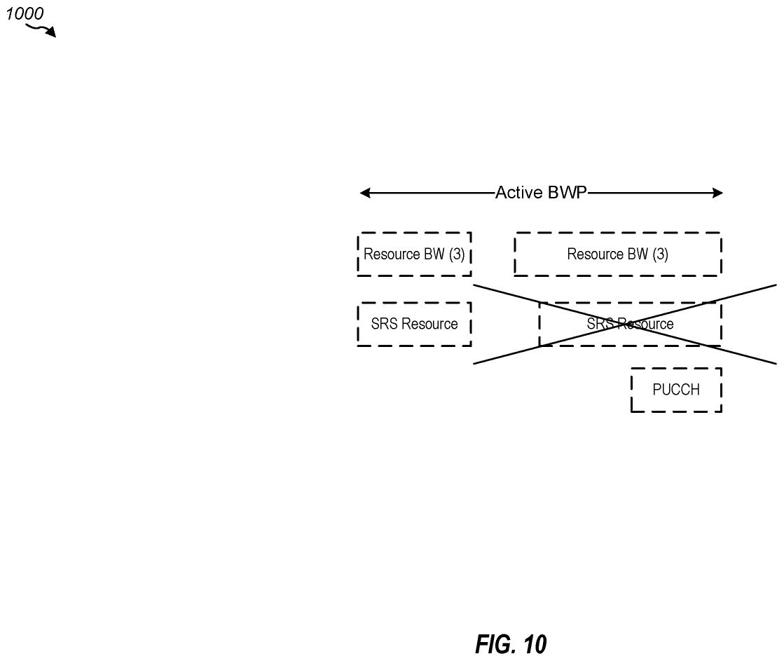

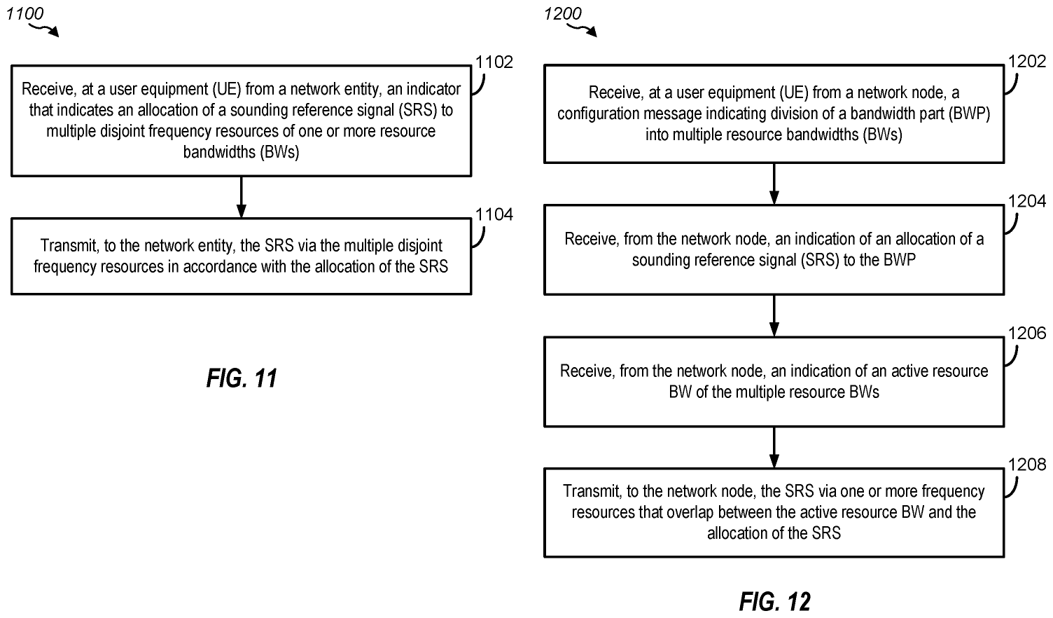

Referring to FIGS. 11 and 12, flow diagrams illustrating example processes performed by a UE are shown. FIG. 11 illustrates an example process 1100 of UE operations for transmitting a SRS via an SRS resource allocated to multiple disjoint frequency resources of one or more resource BWs according to some aspects. FIG. 12 illustrates an example process 1200 of UE operations for transmitting a SRS via SRS resources allocated based on a resource BW of an active BWP according to some aspects. In some implementations, process 1100 and/or process 1200 may be performed by UE 115 or a UE as illustrated in FIG. 13. In some other implementations, process 1100 and/or process 1200 may be performed by an apparatus configured for wireless communication. For example, the apparatus may include at least one processor, and a memory coupled to the processor. The processor may be configured to perform operations of process 1100 and/or process 1200. In some other implementations, process 1100 and/or process 1200 may be performed or executed using a non-transitory computer-readable medium having program code recorded thereon. The program code may be program code executable by a computer for causing the computer to perform operations of process 1100 and/or process 1200.

Example operations (also referred to as “blocks”) of processes 1100 and 1200 will also be described with respect to UE 1300 as illustrated in FIG. 13. FIG. 13 is a block diagram illustrating an example UE 1300 configured to transmit a SRS based on an SRS resource allocation according to some aspects. UE 1300 includes the structure, hardware, and components as illustrated for UE 115 of FIG. 2, 6, or 8. For example, UE 1300 includes controller/processor 280, which operates to execute logic or computer instructions stored in memory 282, as well as controlling the components of UE 1300 that provide the features and functionality of UE 1300. UE 1300, under control of controller/processor 280, transmits and receives signals via wireless radios 1301a-r and antennas 252a-r. Wireless radios 1301a-r include various components and hardware, as illustrated in FIG. 2 for UE 115, including modulator/demodulators 254a-r, MIMO detector 256, receive processor 258, transmit processor 264, and TX MIMO processor 266.

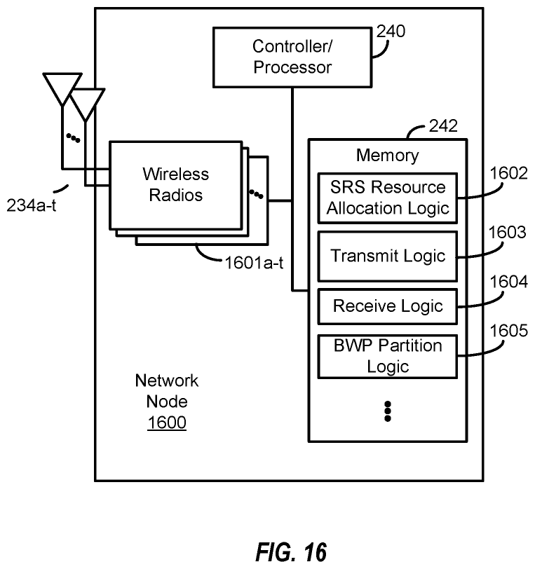

As shown, memory 282 may include receive logic 1302, SRS generation logic 1303, and transmit logic 1304. Receive logic 1302 may be configured to receive information or signaling from a network entity or network node (or other electronic/communication device), such as an indication of an allocation of an SRS resource or selection of an active resource BW within a BWP. SRS generation logic 1303 may be configured to generate an SRS according to the allocation of the SRS resource. Transmit logic 1304 may be configured to enable transmission of signaling or messages to the network entity or network node, such as the SRS. UE 1300 may receive signals from or transmit signals to one or more network entities, such as base station 105 of FIGS. 1-2, network entity 650 of FIG. 6, network node 850 of FIG. 8, a core network, a core network device, or a network node as illustrated in FIG. 16, or one or more other electronic/communication devices (e.g., another UE or other peer or a scheduling entity, as non-limiting examples).

Returning to process 1100 described with reference to FIG. 11, as illustrated at block 1102, UE 1300 receives, from a network entity (e.g., an electronic device), an indicator that indicates an allocation of a SRS to multiple disjoint frequency resources of one or more resource BWs. As an example of block 1102, UE 1300 may receive an indicator using wireless radios 1301a-r and antennas 252a-r, and using receive logic 1302. For example, UE 1300 may execute, under control of controller/processor 280, receive logic 1302 stored in memory 282. The execution environment of receive logic 1302 provides the functionality to receive, from a network entity, an indicator that indicates an allocation of a SRS to multiple disjoint frequency resources of one or more resource BWs. In some implementations, the one or more resource BWs may be within a BWP (e.g., an active BWP) of a CC.

At block 1104, UE 1300 transmits, to the network entity, the SRS via the multiple disjoint frequency resources in accordance with the allocation of the SRS. To illustrate, UE 1300 may transmit the SRS using wireless radios 1301a-r and antennas 252a-r. To further illustrate, UE 1300 may execute, under control of controller/processor 280, SRS generation logic 1303 and transmit logic 1304 stored in memory 282. The execution environment of SRS generation logic 1303 provides the functionality to generate the SRS (e.g., based on a SRS sequence, in some implementations). The execution environment of transmit logic 1304 provides the functionality to transmit the SRS to the network entity via the multiple disjoint frequency resources in accordance with the allocation of the SRS.

In some implementations, the SRS resource includes a single SRS resource. Alternatively, the SRS resource may include a single SRS resource set. Additionally or alternatively, the one or more resource BWs and the BWP may correspond to one or more frequency resources allocated for UL data and signal transmissions from UE 1300 to the network entity.

In some implementations, DL data to another UE is transmitted by the network entity via at least one intervening frequency resource between the multiple disjoint frequency resources. Alternatively, process 1100 may further include receiving DL data from the network entity via at least one intervening frequency resource between the multiple disjoint frequency resources, at least one overlapping frequency resource with one or more of the multiple disjoint frequency resources, or a combination thereof. In some such implementations, the SRS may be transmitted via a first antenna panel of UE 1300, and the DL data may be received via a second antenna panel of UE 1300. Alternatively, the SRS may be transmitted via a first subset of a plurality of antennas of UE 1300, and the DL data is received via a second subset of the plurality of antennas. In some such implementations, the multiple disjoint frequency resources may include multiple non-contiguous frequency sub-bands, and the multiple non-contiguous frequency sub-bands do not overlap with at least one frequency sub-band corresponding to the at least one intervening frequency resource. Additionally or alternatively, a guard band may be allocated between a first frequency resource of the multiple disjoint frequency resources and a first intervening frequency resource. Alternatively, the multiple disjoint frequency resources may include multiple non-contiguous frequency sub-bands, and at least a portion of the multiple non-contiguous frequency sub-bands overlap with at least a portion of a frequency sub-band corresponding to the at least one overlapping frequency resource. Additionally or alternatively, the multiple disjoint frequency resources and the at least one intervening frequency resource, the at least one overlapping frequency resource, or a combination thereof, may be associated with one or more overlapping time resources (e.g., may correspond to a same set of symbols or other time period).

In some implementations, the multiple disjoint frequency resources may include multiple non-contiguous frequency sub-bands that do not overlap with at least one intervening frequency sub-band corresponding to receipt of DL data from the network entity. Alternatively, the multiple disjoint frequency resources may include multiple non-contiguous frequency sub-bands that overlap with at least a portion of an intervening frequency sub-band corresponding to receipt of DL data from the network entity.

In some implementations, transmitting the SRS includes transmitting the SRS during the same set of symbols via the multiple disjoint frequency resources. Additionally or alternatively, receiving the indicator may include receiving a RRC configuration message from the network entity. The RRC configuration message includes the indicator. In some such implementations, the allocation of the one or more SRS resources may be indicated by a set of frequency domain parameters included in the RRC configuration message. The set of frequency domain parameters include frequency domain parameters associated with each frequency resource of the multiple disjoint frequency resources. In some such implementations, each set of frequency domain parameters may include a position parameter that indicates a starting RBG of the corresponding frequency resource and a shift parameter that indicates a part within the starting RBG. In some such implementations, at least one set of frequency domain parameters may include a frequency hopping parameter that indicates a frequency hopping pattern within a corresponding frequency resource for the one or more SRS resources.

In some implementations, process 1100 further includes selecting a corresponding ZC sequence for each frequency resource of the multiple disjoint frequency resources from the same group of ZC sequences. In some such implementations, each ZC sequence of the group may be associated with the same first variable value, and each ZC sequence of the group may be associated with a different second variable value.

FIG. 12 illustrates a flow chart of process 1200. As illustrated at block 1202, UE 1300 receives, from a network node (e.g., an electronic device), a configuration message indicating division of a BWP into multiple resource BWs. As an example of block 1202, UE 1300 may receive a message using wireless radios 1301a-r and antennas 252a-r, and using receive logic 1302. For example, UE 1300 may execute, under control of controller/processor 280, receive logic 1302 stored in memory 282. The execution environment of receive logic 1302 provides the functionality to receive, from a network node, a configuration message indicating division of a BWP into multiple resource BWs.

At block 1204, UE 1300 receives, from the network node, an indication of an allocation of a SRS to the BWP. As an example of block 1204, UE 1300 may receive an indication using wireless radios 1301a-r and antennas 252a-r, and using receive logic 1302. For example, UE 1300 may execute, under control of controller/processor 280, receive logic 1302 stored in memory 282. The execution environment of receive logic 1302 provides the functionality to receive, from the network node, an indication of an allocation of a SRS to the BWP.

At block 1206, UE 1300 receives, from the network node, an indication of an active resource BW of the multiple resource BWs. As an example of block 1206, UE 1300 may receive an indication using wireless radios 1301a-r and antennas 252a-r, and using receive logic 1302. For example, UE 1300 may execute, under control of controller/processor 280, receive logic 1302 stored in memory 282. The execution environment of receive logic 1302 provides the functionality to receive, from the network node, an indication of an active resource BW of the multiple resource BWs.

At block 1208, UE 1300 transmits, to the network node, the SRS via one or more frequency resources that overlap between the active resource BW and the allocation of the SRS. To illustrate, UE 1300 may transmit the SRS using wireless radios 1301a-r and antennas 252a-r, and transmit logic 1304. To further illustrate, UE 1300 may execute, under control of controller/processor 280, SRS generation logic 1303 and transmit logic 1304 stored in memory 282. The execution environment of SRS generation logic 1303 provides the functionality to generate a SRS (e.g., based on a SRS sequence, as a non-limiting example). The execution environment of transmit logic 1304 provides the functionality to transmit, to the network node, the SRS via one or more frequency resources that overlap between the active resource BW and the allocation of the SRS.

In some implementations, the SRS resource includes a single SRS resource. Alternatively, the SRS resource may include a single SRS resource set.

In some implementations, the active resource BW may include at least two disjoint frequency sub-bands. Alternatively, the active resource BW may include a single contiguous frequency sub-band. Additionally or alternatively, process 1200 may further include generating the SRS based on a SRS sequence configured to maintain orthogonality when different portions of the SRS are transmitted via different disjoint frequency sub-bands of the active resource BW.

In some implementations, the network node includes a base station, and the active resource BW is allocated for one or more UL communications from UE 1300 to the base station. In some such implementations, receiving the indication of the active resource BW may include receiving DCI from the network node. The DCI includes the indication of the active resource BW. Alternatively, the network node may include a second UE, and the active resource BW may be allocated for one or more SL communications between UE 1300 and the second UE. In some such implementations, receiving the indication of the active resource BW may include receiving SCI from the network node. The SCI includes the indication of the active resource BW.

In some implementations, the configuration message may include a RRC configuration message. In some such implementations, the RRC configuration message may include a frequency hopping parameter that indicates a frequency hopping pattern of one or more SRS resources of the SRS within the active resource BW.

In some implementations, process 1200 further includes determining that a first portion of the allocation of the SRS will collide with a channel transmitted via the active resource BW. The channel is associated with a higher priority than the SRS. The SRS is transmitted via a second portion of the allocation of the SRS. In some such implementations, the channel includes a PUCCH, a PSCCH, or a PRACH.

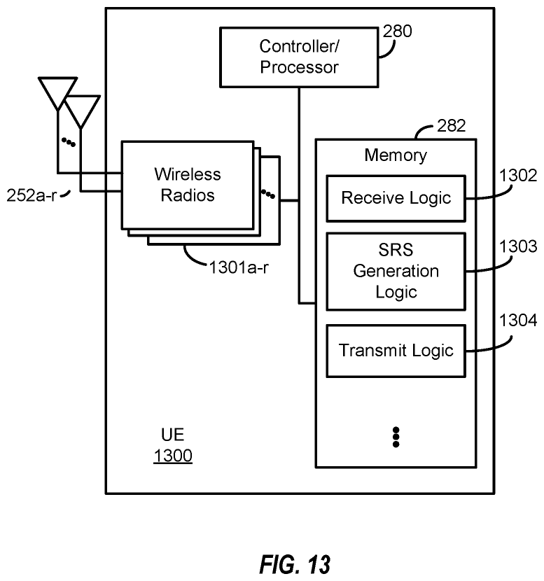

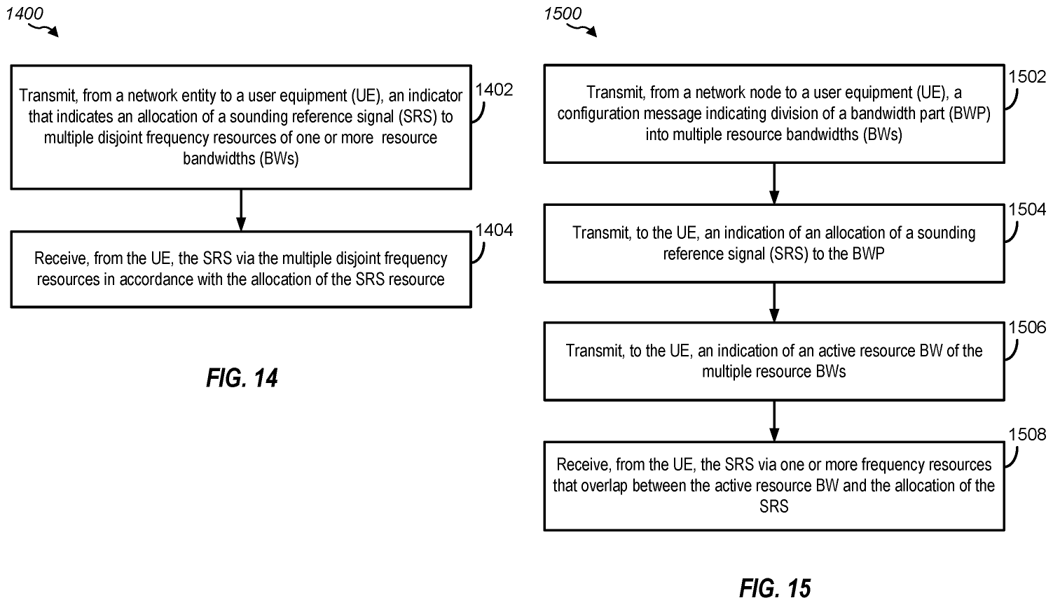

FIGS. 14 and 15 are flow diagrams illustrating example processes performed by a network entity or a network node according to some aspects. Although described as being performed by a network entity, in some other implementations, the processes may be performed by another type of electronic/communication device, such as another UE (e.g., a peer) or a scheduling entity, as non-limiting examples. FIG. 14 illustrates an example process 1400 of network entity operations for indicating an allocation of an SRS resource to multiple disjoint frequency resources of one or more resource BWs according to some aspects. FIG. 15 illustrates an example process 1500 of network node operations for indicating an allocation of SRS resources based on a resource BW of an active BWP according to some aspects. In some implementations, any of process 1400 and/or process 1500 may be performed by network entity 650 of FIG. 6, network node 850 of FIG. 8, or a network node as described with reference to FIG. 16, or an electronic/communication device (e.g., a peer or a scheduling entity). In some other implementations, any of process 1400 and/or process 1500 may be performed by an apparatus configured for wireless communication. For example, the apparatus may include at least one processor, and a memory coupled to the processor. The processor may be configured to perform operations of any of the process 1400 and/or process 1500. In some other implementations, any of the process 1400 and/or process 1500 may be performed or executed using a non-transitory computer-readable medium having program code recorded thereon. The program code may be program code executable by a computer for causing the computer to perform operations of any of the process 1400 and/or process 1500.

Example blocks of the processes 1400 and 1500 will also be described with respect to a network node 1600 as illustrated in FIG. 16. FIG. 16 is a block diagram illustrating an example of network node 1600 configured to indicate one or more allocations of an SRS resource according to some aspects. Network node 1600 may include base station 105, network entity 650, network node 850, a network, a core network, or a UE, as illustrative, non-limiting examples. Network node 1600 includes the structure, hardware, and components as illustrated for base station 105 of FIGS. 1 and 2, network entity 650 of FIG. 6, network node 850 of FIG. 8, or a combination thereof. For example, network node 1600 may include controller/processor 240, which operates to execute logic or computer instructions stored in memory 242, as well as controlling the components of network node 1600 that provide the features and functionality of network node 1600. Network node 1600, under control of controller/processor 240, transmits and receives signals via wireless radios 1601a-t and antennas 234a-t. Wireless radios 1601a-t include various components and hardware, as illustrated in FIG. 2 for base station 105, including modulator/demodulators 232a-t, transmit processor 220, TX MIMO processor 230, MIMO detector 236, and receive processor 238.

As shown, memory 242 may include SRS resource allocation logic 1602, transmit logic 1603, receive logic 1604, and BWP partition logic 1605. SRS resource allocation logic 1602 may be configured to allocate one or more SRS resources to multiple disjoint frequency resources of one or more resource BWs. Transmit logic 1603 may be configured to initiate transmission of information or signals to a UE, such as an indication of the allocation of the SRS resource or a configuration message. Receive logic 1604 may be configured to enable receipt of information or signals, such as a SRS from the UE. BWP partition logic 1605 may be configured to divide a BWP into multiple resource BWs. Network node 1600 may receive signals from or transmit signals to one or more UEs, such as UE 115 of FIGS. 1-2, 6, and 8 or UE 1300 of FIG. 13.

Returning to process 1400 described with reference to FIG. 14, as illustrated at block 1402, network node 1600 (e.g., an electronic device) transmits, to a UE, an indicator that indicates an allocation of a SRS to multiple disjoint frequency resources of one or more resource BWs. To illustrate, network node 1600 may transmit the indicator using wireless radios 1601a-t and antennas 234a-t, and SRS resource allocation logic 1602 and transmit logic 1603. To further illustrate, network node 1600 may execute, under control of controller/processor 240, SRS resource allocation logic 1602 and transmit logic 1603 stored in memory 242. The execution environment of SRS resource allocation logic 1602 provides the functionality to allocate a SRS to multiple disjoint frequency resources of one or more resource BWs. The execution environment of transmit logic 1603 provides the functionality to transmit an indicator that indicates the allocation to the UE. In some implementations, the one or more resource BWs may be within a BWP (e.g., an active BWP) of a CC.

At block 1404, network node 1600 receives, from the UE, the SRS via the multiple disjoint frequency resources in accordance with the allocation of the SRS. To illustrate, network node 1600 may receive the SRS using wireless radios 1601a-t and antennas 234a-t, and receive logic 1604. To further illustrate, network node 1600 may execute, under control of controller/processor 240, receive logic 1604 stored in memory 242. The execution environment of receive logic 1604 provides the functionality to receive, from the UE, the SRS via the multiple disjoint frequency resources in accordance with the allocation of the SRS.

In some implementations, the SRS resource includes a single SRS resource. Alternatively, the SRS resource may include a single SRS resource set. Additionally or alternatively, the one or more resource BWs and the BWP may correspond to one or more frequency resources allocated for UL data and signal transmissions from the UE to network node 1600.

In some implementations, process 1400 further includes transmitting, to another UE, DL data via the at least one intervening frequency resource between the multiple disjoint frequency resources. Alternatively, process 1400 may further include transmitting DL data to the UE via at least one intervening frequency resource between the multiple disjoint frequency resources, at least one overlapping frequency resource with the multiple disjoint frequency resources, or a combination thereof. In some such implementations, the SRS may be received via a first antenna panel of network node 1600, and the DL data may be transmitted via a second antenna panel of network node 1600. Alternatively, the SRS may be received via a first subset of a plurality of antennas of network node 1600, and the DL data may be transmitted via a second subset of the plurality of antennas. Additionally or alternatively, the multiple disjoint frequency resources may be allocated for UL communications from the UE to network node 1600, and the at least one intervening frequency resource may be allocated for DL communications from network node 1600 to the UE. In some such implementations, the multiple disjoint frequency resources may include multiple non-contiguous frequency sub-bands, and the multiple non-contiguous frequency sub-bands may not overlap with at least one frequency sub-band corresponding to the at least one intervening frequency resource. Additionally or alternatively, a guard band may be allocated between a first frequency resource of the multiple disjoint frequency resources and a first intervening frequency resource. Additionally or alternatively, the multiple disjoint frequency resources and the at least one intervening frequency resource, the at least one overlapping frequency resource, or both, may be associated with one or more overlapping time resources (e.g., may correspond to a same set of symbols or other time period).

In some implementations, the multiple disjoint frequency resources may include multiple non-contiguous frequency sub-bands that do not overlap with at least one intervening frequency sub-band corresponding to transmission of DL data to the UE. Alternatively, the multiple disjoint frequency resources may include multiple non-contiguous frequency sub-bands that overlap with at least a portion of an intervening frequency sub-band corresponding to transmission of DL data to the UE.

In some implementations, receiving the SRS may include receiving the SRS during the same set of symbols via the multiple disjoint frequency resources. Additionally or alternatively, transmitting the indicator may include transmitting a RRC configuration message to the UE. The RRC configuration message includes the indicator. In some such implementations, the allocation of the one or more SRS resources may be indicated by a set of frequency domain parameters included in the RRC configuration message. The set of frequency domain parameters may include frequency domain parameters associated with each frequency resource of the multiple disjoint frequency resources. In some such implementations, each set of frequency domain parameters may include a position parameter that indicates a starting RBG of the corresponding frequency resource and a shift parameter that indicates a part within the starting RBG. In some such implementations, at least one set of frequency domain parameters may include a frequency hopping parameter that indicates a frequency hopping pattern within a corresponding frequency resource for the SRS resource.

FIG. 15 illustrates a flow diagram of process 1500. As illustrated at block 1502, network node 1600 (e.g., an electronic device) transmits, to a UE, a configuration message indicating division of a BWP into multiple resource BWs. To illustrate, network node 1600 may transmit the configuration message using wireless radios 1601a-t and antennas 234a-t, and BWP partition logic 1605 and transmit logic 1603. To further illustrate, network node 1600 may execute, under control of controller/processor 240, BWP partition logic 1605 and transmit logic 1603 stored in memory 242. The execution environment of BWP partition logic 1605 provides the functionality to divide (e.g., partition) a BWP into multiple resource BWs. The execution environment of transmit logic 1603 provides the functionality to transmit a configuration message indicating the division of the BWP to a UE.

At block 1504, network node 1600 transmits, to the UE, an indication of an allocation of a SRS to the BWP. To illustrate, network node 1600 may transmit the indication using wireless radios 1601a-t and antennas 234a-t, and transmit logic 1603. To further illustrate, network node 1600 may execute, under control of controller/processor 240, transmit logic 1603 stored in memory 242. The execution environment of transmit logic 1603 provides the functionality to transmit, to the UE, an indication of an allocation of an SRS to the BWP.

At block 1506, network node 1600 transmits, to the UE, an indication of an active resource BW of the multiple resource BWs. To illustrate, network node 1600 may transmit the indication using wireless radios 1601a-t and antennas 234a-t, and transmit logic 1603. To further illustrate, network node 1600 may execute, under control of controller/processor 240, transmit logic 1603 stored in memory 242. The execution environment of transmit logic 1603 provides the functionality to transmit, to the UE, an indication of an active resource BW of the multiple resource BWs.

At block 1508, network node 1600 receives, from the UE, the SRS via one or more frequency resources that overlap between the active resource BW and the allocation of the SRS. To illustrate, network node 1600 may receive the SRS using wireless radios 1601a-t and antennas 234a-t, and receive logic 1604. To further illustrate, network node 1600 may execute, under control of controller/processor 240, receive logic 1604 stored in memory 242. The execution environment of receive logic 1604 provides the functionality to receive, from the UE, the SRS via one or more frequency resources that overlap between the active resource BW and the allocation of the SRS.

In some implementations, the SRS resource may include a single SRS resource. Alternatively, the SRS resource may include a single SRS resource set.

In some implementations, the active resource BW may include at least two disjoint frequency sub-bands. Alternatively, the active resource BW may include a single contiguous frequency sub-band.

In some implementations, network node 1600 includes a base station, and the active resource BW is allocated for one or more UL communications from the UE to the base station. In some such implementations, transmitting the indication of the active resource BW may include transmitting DCI to the UE. The DCI includes the indication of the active resource BW. Alternatively, the network node may include a second UE, and the active resource BW may be allocated for one or more SL communications between the UE and the second UE. In some such implementations, transmitting the indication of the active resource BW may include transmitting SCI to the UE. The SCI includes the indication of the active resource BW.

In some implementations, the configuration message may include a RRC configuration message. In some such implementations, the RRC configuration message may include a frequency hopping parameter that indicates a frequency hopping pattern of the SRS within the active resource BW.

It is noted that one or more blocks (or operations) described with reference to FIGS. 11, 12, 14, and 15 may be combined with one or more blocks (or operations) of another figure. For example, one or more blocks (or operations) of FIG. 11 may be combined with one or more blocks (or operations) FIG. 12. As another example, one or more blocks of FIGS. 11, 12, 14, and 15 may be combined with one or more blocks (or operations) of another of FIG. 2, 3, 6, 8, or 13. Additionally, or alternatively, one or more operations described above with reference to FIGS. 1-15 may be combined with one or more operations described with reference to FIG. 16.

In some aspects, techniques for enabling allocation of an SRS to multiple disjoint frequency resources of one or more resource BWs may include additional aspects, such as any single aspect or any combination of aspects described below and/or in connection with one or more other processes or devices described elsewhere herein. In some aspects, enabling allocation of an SRS to multiple disjoint frequency resources of one or more resource BWs may include an apparatus receiving, from a network entity (e.g., an electronic device), an indicator that indicates an allocation of an SRS to multiple disjoint frequency resources of one or more resource BWs (such as within a BWP). The apparatus may also transmit, to the network entity/electronic device, the SRS via the multiple disjoint frequency resources in accordance with the allocation of the SRS. In some implementations, the apparatus includes a wireless device, such as a UE. In some implementations, the apparatus may include at least one processor, and a memory coupled to the processor. The processor may be configured to perform operations described herein with respect to the wireless device. In some other implementations, the apparatus may include a non-transitory computer-readable medium having program code recorded thereon and the program code may be executable by a computer for causing the computer to perform operations described herein with reference to the wireless device. In some implementations, the apparatus may include one or more means configured to perform operations described herein.

In a first aspect, the SRS resource includes a single SRS resource.

In a second aspect, the SRS resource includes a single SRS resource set.

In a third aspect, alone or in combination with one or more of the first through second aspects, the one or more resource BWs correspond to one or more frequency resources allocated for UL data and signal transmissions from the UE to the network entity/electronic device.

In a fourth aspect, alone or in combination with one or more of the first through third aspects, DL data addressed to another UE is transmitted by the network entity/electronic device via at least one intervening frequency resource between the multiple disjoint frequency resources.

In a fifth aspect, alone or in combination with one or more of the first through third aspects, the apparatus receives DL data from the network entity/electronic device via at least one intervening frequency resource between the multiple disjoint frequency resources, at least one overlapping frequency resource with one or more of the multiple disjoint frequency resources, or a combination thereof.

In a sixth aspect, in combination with the fourth aspect, the SRS is transmitted via one or more antenna elements or a first antenna panel of the UE, and the DL data is received via one or more other antenna elements or a second antenna panel of the UE.

In a seventh aspect, in combination with the fourth aspect, the SRS is transmitted via a first subset of a plurality of antennas of the UE, and the DL data is received via a second subset of the plurality of antennas.

In an eighth aspect, alone or in combination with one or more of the fifth through seventh aspects, the multiple disjoint frequency resources are allocated for UL communications from the UE to the network entity/electronic device, and the at least one intervening frequency resource, the at least one overlapping frequency resource, or a combination thereof, is allocated for DL communications from the network entity/electronic device to the UE.

In a ninth aspect, alone or in combination with one or more of the first through eighth aspects, the multiple disjoint frequency resources comprise multiple non-contiguous frequency sub-bands, and the multiple non-contiguous frequency sub-bands do not overlap with at least one frequency sub-band corresponding to the at least one intervening frequency resource.

In a tenth aspect, alone or in combination with one or more of the first through ninth aspects, a guard band is allocated between a first frequency resource of the multiple disjoint frequency resources and a first intervening frequency resource.

In an eleventh aspect, alone or in combination with one or more of the eighth through tenth aspects, the multiple disjoint frequency resources and the at least one intervening frequency resource, the at least one overlapping frequency resource, or a combination thereof, are associated with one or more overlapping time resources.

In a twelfth aspect, alone or in combination with one or more of the first through tenth aspects, the multiple disjoint frequency resources include multiple non-contiguous frequency sub-bands, and at least a portion of the multiple non-contiguous frequency sub-bands overlap with at least a portion of a frequency sub-band corresponding to the at least one overlapping frequency resource.

In a thirteenth aspect, alone or in combination with one or more of the first through twelfth aspects, transmitting the SRS comprises transmitting the SRS during the same set of symbols via the multiple disjoint frequency resources.

In a fourteenth aspect, alone or in combination with one or more of the first through thirteenth aspects, receiving the indicator comprises receiving a RRC configuration message from the network entity/electronic device. The RRC configuration message includes the indicator. The allocation of the one or more SRS resources is indicated by a set of frequency domain parameters included in the RRC configuration message. The set of frequency domain parameters include frequency domain parameters associated with each frequency resource of the multiple disjoint frequency resources.

In a fifteenth aspect, in combination with the fourteenth aspect, each set of frequency domain parameters includes a position parameter that indicates a starting RBG of the corresponding frequency resource and a shift parameter that indicates a part within the starting RBG.

In a sixteenth aspect, in combination with the fifteenth aspect, at least one set of frequency domain parameters includes a frequency hopping parameter that indicates a frequency hopping pattern within a corresponding frequency resource for the allocation of the SRS.

In a seventeenth aspect, alone or in combination with one or more of the first through sixteenth aspects, the apparatus selects a corresponding ZC sequence for each frequency resource of the multiple disjoint frequency resources from the same group of ZC sequences.

In an eighteenth aspect, in combination with the seventeenth aspect, each ZC sequence of the group is associated with the same first variable value, and each ZC sequence of the group is associated with a different second variable value.

In some aspects, an apparatus configured for wireless communication, such as a network entity (e.g., an electronic device), is configured to transmit, to a UE, an indicator that indicates an allocation of an SRS to multiple disjoint frequency resources of one or more resource BWs (such as within a BWP). The apparatus is also configured to receive, from the UE, the SRS via the multiple disjoint frequency resources in accordance with the allocation of the SRS. In some implementations, the apparatus includes a wireless device, such as a network entity or other electronic/communication device (e.g., a peer or scheduling entity). In some implementations, the apparatus may include at least one processor, and a memory coupled to the processor. The processor may be configured to perform operations described herein with respect to the wireless device. In some other implementations, the apparatus may include a non-transitory computer-readable medium having program code recorded thereon and the program code may be executable by a computer for causing the computer to perform operations described herein with reference to the wireless device. In some implementations, the apparatus may include one or more means configured to perform operations described herein.

In a nineteenth aspect, the SRS resource includes a single SRS resource.

In a twentieth aspect, the SRS resource includes a single SRS resource set.

In a twenty-first aspect, alone or in combination with one or more of the nineteenth through twentieth aspects, the one or more resource BWs correspond to one or more frequency resources allocated for UL data and signal transmissions from the UE to the network entity/electronic device.

In a twenty-second aspect, alone or in combination with one or more of the nineteenth through twenty-first aspects, the apparatus transmits, to another UE, DL data via at least one intervening frequency resource between the multiple disjoint frequency resources, at least one overlapping frequency resource with one or more of the multiple disjoint frequency resources, or a combination thereof.

In a twenty-third aspect, alone or in combination with one or more of the nineteenth through twenty-first aspects, the apparatus transmits DL data to the UE via at least one intervening frequency resource between the multiple disjoint frequency resources, the at least one overlapping frequency resource, or a combination thereof.

In a twenty-fourth aspect, in combination with the twenty-third aspect, the SRS is received via a first antenna panel of the network entity/electronic device, and the DL data is transmitted via a second antenna panel of the network entity/electronic device.

In a twenty-fifth aspect, in combination with the twenty-third aspect, the SRS is received via a first subset of a plurality of antennas of the network entity/electronic device, and the DL data is transmitted via a second subset of the plurality of antennas.

In a twenty-sixth aspect, alone or in combination with one or more of the twenty-third through twenty-fifth aspects, the multiple disjoint frequency resources are allocated for UL communications from the UE to the network entity/electronic device, and the at least one intervening frequency resource is allocated for DL communications from the network entity/electronic device to the UE.

In a twenty-seventh aspect, in combination with one or more of the nineteenth through twenty-sixth aspects, the multiple disjoint frequency resources comprise multiple non-contiguous frequency sub-bands, and the multiple non-contiguous frequency sub-bands do not overlap with at least one frequency sub-band corresponding to the at least one intervening frequency resource.

In a twenty-eighth aspect, alone or in combination with one or more of the nineteenth through twenty-seventh aspects a guard band is allocated between a first frequency resource of the multiple disjoint frequency resources and a first intervening frequency resource.

In a twenty-ninth aspect, alone or in combination with one or more of the nineteenth through twenty-eighth aspects, the multiple disjoint frequency resources and the at least one intervening frequency resource are associated with one or more overlapping time resources.

In a thirtieth aspect, alone or in combination with one or more of the nineteenth through twenty-ninth aspects, receiving the SRS comprises receiving the SRS during the same set of symbols via the multiple disjoint frequency resources.

In a thirty-first aspect, alone or in combination with one or more of the nineteenth through thirtieth aspects, transmitting the indicator comprises transmitting a RRC configuration message to the UE. The RRC configuration message includes the indicator.

In a thirty-second aspect, in combination with the thirty-first aspect, the allocation of the SRS is indicated by a corresponding set of frequency domain parameters included in the RRC configuration message. The set of frequency domain parameters include frequency domain parameters associated with each frequency resource of the multiple disjoint frequency resources.

In a thirty-third aspect, in combination with the thirty-second aspect, each set of frequency domain parameters includes a position parameter that indicates a starting RBG of the corresponding frequency resource and a shift parameter that indicates a part within the starting RBG.

In a thirty-fourth aspect, in combination with the thirty-third aspect, at least one set of frequency domain parameters includes a frequency hopping parameter that indicates a frequency hopping pattern within a corresponding frequency resource for the SRS.

In some aspects, an apparatus configured for wireless communication, such as a UE, is configured to receive, from a network node (e.g., an electronic device), a configuration message indicating division of a BWP into multiple resource BWs. The apparatus is configured to receive, from the network node/electronic device, an indication of an allocation of a SRS to the BWP. The apparatus is also configured to receive, from the network node/electronic device, an indication of an active resource BW of the multiple resource BWs. The apparatus is further configured to transmit, to the network node/electronic device, the SRS via one or more frequency resources that overlap between the active resource BW and the allocation of the SRS. In some implementations, the apparatus includes a wireless device, such as a UE. In some implementations, the apparatus may include at least one processor, and a memory coupled to the processor. The processor may be configured to perform operations described herein with respect to the wireless device. In some other implementations, the apparatus may include a non-transitory computer-readable medium having program code recorded thereon and the program code may be executable by a computer for causing the computer to perform operations described herein with reference to the wireless device. In some implementations, the apparatus may include one or more means configured to perform operations described herein.

In a thirty-fifth aspect, the SRS resource includes a single SRS resource.

In a thirty-sixth aspect, the SRS resource includes a single SRS resource set.

In a thirty-seventh aspect, alone or in combination with one or more of the thirty-fifth through thirty-sixth aspects, the active resource BW comprises at least two disjoint frequency sub-bands.

In a thirty-eighth aspect, alone or in combination with one or more of the thirty-fifth through thirty-seventh aspects, the active resource BW comprises a single contiguous frequency sub-band.

In a thirty-ninth aspect, alone or in combination with one or more of the thirty-fifth through thirty-eighth aspects, the apparatus generates the SRS based on a SRS sequence configured to maintain orthogonality when different portions of the SRS are transmitted via different disjoint frequency sub-bands of the active resource BW.

In a fortieth aspect, alone or in combination with one or more of the thirty-fifth through thirty-ninth aspects, the network node/electronic device comprises a base station, and the active resource BW is allocated for one or more UL communications from the UE to the base station.

In a forty-first aspect, in combination with the fortieth aspect, receiving the indication of the active resource BW comprises receiving DCI from the network node/electronic device. The DCI includes the indication of the active resource BW.

In a forty-second aspect, alone or in combination with one or more of the thirty-fifth through thirty-ninth aspects, the network node/electronic device comprises a second UE, and the active resource BW is allocated for one or more SL communications between the UE and the second UE.

In a forty-third aspect, in combination with the forty-second aspect, receiving the indication of the active resource BW comprises receiving SCI from the network node/electronic device. The SCI includes the indication of the active resource BW.

In a forty-fourth aspect, alone or in combination with one or more of the thirty-fifth through forty-third aspects, the configuration message comprises a RRC configuration message.

In a forty-fifth aspect, in combination with the forty-fourth aspect, the RRC configuration message includes a frequency hopping parameter that indicates a frequency hopping pattern of the SRS within the active resource BW.

In a forty-sixth aspect, alone or in combination with one or more of the thirty-fifth through forty-fifth aspects, the apparatus determines that a first portion of the allocation of the SRS will collide with a channel transmitted via the active resource BW. The channel is associated with a higher priority than the SRS. The SRS is transmitted via a second portion of the allocation of the SRS.

In a forty-seventh aspect, in combination with the forty-sixth aspect, the channel comprises a PUCCH, a PSCCH, or a PRACH.

In some aspects, an apparatus configured for wireless communication, such as a network node (e.g., an electronic device), is configured to transmit, to a UE, a configuration message indicating division of a BWP into multiple resource BWs. The apparatus is configured to transmit, to the UE, an indication of an allocation of a SRS to the BWP. The apparatus is also configured to transmit, to the UE, an indication of an active resource BW of the multiple resource BWs. The apparatus is further configured to receive, from the UE, the SRS via one or more frequency resources that overlap between the active resource BW and the allocation of the SRS. In some implementations, the apparatus includes a wireless device, such as a network node or other electronic/communication device (e.g., a peer or scheduling entity). In some implementations, the apparatus may include at least one processor, and a memory coupled to the processor. The processor may be configured to perform operations described herein with respect to the wireless device. In some other implementations, the apparatus may include a non-transitory computer-readable medium having program code recorded thereon and the program code may be executable by a computer for causing the computer to perform operations described herein with reference to the wireless device. In some implementations, the apparatus may include one or more means configured to perform operations described herein.

In a forty-eighth aspect, the SRS resource includes a single SRS resource.

In a forty-ninth aspect, the SRS resource includes a single SRS resource set.

In a fiftieth aspect, alone or in combination with one or more of the forty-eighth through forty-ninth aspects, the active resource BW comprises at least two disjoint frequency sub-bands.

In a fifty-first aspect, alone or in combination with one or more of the forty-eighth through forty-ninth aspects, the active resource BW comprises a single contiguous frequency sub-band.

In a fifty-second aspect, alone or in combination with one or more of the forty-eighth through fifty-first aspects, the network node/electronic device comprises a base station, and the active resource BW is allocated for one or more UL communications from the UE to the base station.

In a fifty-third aspect, in combination with the fifty-second aspect, transmitting the indication of the active resource BW comprises transmitting DCI to the UE. The DCI includes the indication of the active resource BW.

In a fifty-fourth aspect, alone or in combination with one or more of the forty-eighth through fifty-first aspects, the network node/electronic device comprises a second UE, and the active resource BW is allocated for one or more SL communications between the UE and the second UE.

In a fifty-fifth aspect, in combination with the fifty-fourth aspect, transmitting the indication of the active resource BW comprises transmitting SCI to the UE, the SCI including the indication of the active resource BW.

In a fifty-sixth aspect, alone or in combination with one or more of the forty-eighth through fifty-fifth aspects, the configuration message comprises a RRC configuration message.

In a fifty-seventh aspect, in combination with the fifty-sixth aspect, the RRC configuration message includes a frequency hopping parameter that indicates a frequency hopping pattern of the SRS within the active resource BW.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks and modules described herein with respect to FIGS. 2, 6, 8, 13, and 16 may comprise processors, electronics devices, hardware devices, electronics components, logical circuits, memories, software codes, firmware codes, etc., or any combination thereof. In addition, features discussed herein relating to FIGS. 1-16 may be implemented via specialized processor circuitry, via executable instructions, and/or combinations thereof.

Those of skill would further appreciate that the various illustrative logical blocks, modules, circuits, and algorithm steps (e.g., the logical blocks in FIGS. 11, 12, 14, and 15) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, the method comprising:
receiving, at a user equipment (UE) from an electronic device, an indicator that indicates an allocation of a sounding reference signal (SRS) to multiple disjoint frequency resources of one or more resource bandwidths (BWs); and
transmitting, to the electronic device, the SRS via the multiple disjoint frequency resources in accordance with the allocation of the SRS.

2. The method of claim 1, further comprising receiving downlink (DL) data from the electronic device via at least one intervening frequency resource between the multiple disjoint frequency resources, at least one overlapping frequency resource with one or more of the multiple disjoint frequency resources, or a combination thereof.

3. The method of claim 2, wherein the SRS is transmitted via a one or more antenna elements or an antenna panel of the UE, and wherein the DL data is received via one or more other antenna elements or an antenna panel of the UE.

4. The method of claim 2, wherein the multiple disjoint frequency resources are allocated for uplink (UL) communications from the UE to the electronic device, and wherein the at least one intervening frequency resource, the at least one overlapping frequency resource, or a combination thereof, is allocated for DL communications from the electronic device to one or more UEs.

5. The method of claim 4, wherein the multiple disjoint frequency resources and the at least one intervening frequency resource, the at least one overlapping frequency resource, or a combination thereof, are associated with one or more overlapping time resources.

6. The method of claim 4, wherein a guard band is allocated between a first frequency resource of the multiple disjoint frequency resources and a first intervening frequency resource.

7. The method of claim 1, wherein the multiple disjoint frequency resources comprise multiple non-contiguous frequency sub-bands, and wherein the multiple non-contiguous frequency sub-bands do not overlap with at least one intervening frequency sub-band corresponding to receipt of downlink (DL) data from the electronic device.

8. The method of claim 1, wherein the multiple disjoint frequency resources comprise multiple non-contiguous frequency sub-bands, and wherein at least a portion of the multiple non-contiguous frequency sub-bands overlap with at least a portion of an intervening frequency sub-band corresponding to receipt of downlink (DL) data from the electronic device.

9. The method of claim 1, wherein transmitting the SRS comprises transmitting the SRS during the same set of symbols via the multiple disjoint frequency resources.

10. The method of claim 1, wherein receiving the indicator comprises receiving a radio resource control (RRC) configuration message from the electronic device, the RRC configuration message including the indicator, and wherein the allocation of the SRS is indicated by a set of frequency domain parameters included in the RRC configuration message, the set of frequency domain parameters including frequency domain parameters associated with each frequency resource of the multiple disjoint frequency resources.

11. The method of claim 10, wherein each set of frequency domain parameters includes a position parameter that indicates a starting resource block group (RBG) of the corresponding frequency resource and a shift parameter that indicates a part within the starting RBG.

12. The method of claim 11, wherein at least one set of frequency domain parameters includes a frequency hopping parameter that indicates a frequency hopping pattern within a corresponding frequency resource for the allocation of the SRS.

13. The method of claim 1, further comprising selecting a corresponding Zadoff Chu (ZC) sequence for each frequency resource of the multiple disjoint frequency resources from the same group of ZC sequences, wherein each ZC sequence of the group is associated with the same first variable value, and wherein each ZC sequence of the group is associated with a different second variable value.

14. An apparatus configured for wireless communication, the apparatus comprising:
at least one processor; and
a memory coupled to the at least one processor,
wherein the at least one processor is configured to:
receive, at a user equipment (UE) from an electronic device, an indicator that indicates an allocation of a sounding reference signal (SRS) to multiple disjoint frequency resources of one or more resource bandwidths (BWs); and
initiate transmission, to the electronic device, of the SRS via the multiple disjoint frequency resources in accordance with the allocation of the SRS.

15. The apparatus of claim 14, wherein the SRS includes one or more SRS resources, and wherein the one or more resource BWs are within a bandwidth part (BWP).

16. The apparatus of claim 14, wherein the one or more resource BWs correspond to one or more frequency resources allocated for uplink (UL) data and signal transmissions from the UE to the electronic device.

17. The apparatus of claim 14, wherein downlink (DL) data addressed to another UE is transmitted by the electronic device via at least one intervening frequency resource between the multiple disjoint frequency resources, at least one overlapping frequency resource with one or more of the multiple disjoint frequency resources, or a combination thereof.

18. A method of wireless communication, the method comprising:
receiving, at a user equipment (UE) from an electronic device, a configuration message indicating division of a bandwidth part (BWP) into multiple resource bandwidths (BWs);
receiving, from the electronic device, an indication of an allocation of a sounding reference signal (SRS) to the BWP;
receiving, from the electronic device, an indication of an active resource BW of the multiple resource BWs; and
transmitting, to the electronic device, the SRS via one or more frequency resources that overlap between the active resource BW and the allocation of the SRS.

19. The method of claim 18, further comprising generating the SRS based on a SRS sequence configured to maintain orthogonality when different portions of the SRS are transmitted via different disjoint frequency sub-bands of the active resource BW.

20. The method of claim 18, wherein the configuration message comprises a radio resource control (RRC) configuration message.

21. The method of claim 20, wherein the RRC configuration message includes a frequency hopping parameter that indicates a frequency hopping pattern of the SRS within the active resource BW.

22. The method of claim 18, further comprising determining that a first portion of the allocation of the SRS will collide with a channel transmitted via the active resource BW, the channel associated with a higher priority than the SRS, and wherein the SRS is transmitted via a second portion of the allocation of the SRS.

23. The method of claim 22, wherein the channel comprises a physical uplink control channel (PUCCH), a physical sidelink control channel (PSCCH), or a physical random access channel (PRACH).

24. An apparatus configured for wireless communication, the apparatus comprising:
at least one processor; and
a memory coupled to the at least one processor,
wherein the at least one processor is configured to:
receive, at a user equipment (UE) from an electronic device, a configuration message indicating division of a bandwidth part (BWP) into multiple resource bandwidths (BWs);
receive, from the electronic device, an indication of an allocation of a sounding reference signal (SRS) to the BWP;
receive, from the electronic device, an indication of an active resource BW of the multiple resource BWs; and
initiate transmission, to the electronic device, of the SRS via one or more frequency resources that overlap between the active resource BW and the allocation of the SRS.

25. The apparatus of claim 24, wherein the active resource BW comprises at least two disjoint frequency sub-bands.

26. The apparatus of claim 24, wherein the active resource BW comprises a single contiguous frequency sub-band.

27. The apparatus of claim 24, wherein the electronic device comprises a base station, and wherein the active resource BW is allocated for one or more uplink (UL) communications from the UE to the base station.

28. The apparatus of claim 27, wherein receiving the indication of the active resource BW comprises receiving downlink control information (DCI) from the electronic device, the DCI including the indication of the active resource BW.

29. The apparatus of claim 24, wherein the electronic device comprises a second UE, and wherein the active resource BW is allocated for one or more sidelink (SL) communications between the UE and the second UE.

30. The apparatus of claim 29, wherein receiving the indication of the active resource BW comprises receiving sidelink control information (SCI) from the electronic device, the SCI including the indication of the active resource BW.
